(19) United States
(12) Patent Application Publication
(10) Pub. No.: US 2020/0284957 A1
(43) Pub. Date: Sep. 10, 2020

(54) OPTICAL ABSORPTION FILTER FOR AN INTEGRATED DEVICE

(71) Applicant: Quantum-Si Incorporated, Guilford, CT (US)

(72) Inventors: Michael Bellos, Lebanon, CT (US); Faisal R. Ahmad, Guilford, CT (US); James Beach, Austin, TX (US); Michael Coumans, Old Lyme, CT (US); Sharath Hosali, Austin, TX (US); Ali Kabiri, Guilford, CT (US); Kyle Preston, Guilford, CT (US); Gerard Schmid, Guilford, CT (US); Bing Shen, Branford, CT (US); Jonathan M. Rothberg, Guilford, CT (US)

(73) Assignee: Quantum-Si Incorporated, Guilford, CT (US)

(21) Appl. No.: 16/809,785

(22) Filed: Mar. 5, 2020

Related U.S. Application Data
(60) Provisional application No. 62/831,237, filed on Apr. 9, 2019.
(60) Provisional application No. 62/813,997, filed on Mar. 5, 2019.

(51) Int. Cl. G02B 5/22; G02B 5/00; G01N 21/64

(52) U.S. Cl. CPC G02B 5/22; B01L 2200/12; G01N 21/6486; G02B 5/003

(57) ABSTRACT

Apparatus and methods relating to attenuating excitation radiation incident on a sensor in an integrated device that is used for sample analysis are described. At least one semiconductor film of a selected material and crystal morphology is located between a waveguide and a sensor in an integrated device that is formed on a substrate. Rejection ratios greater than 100 or more can be obtained for excitation and emission wavelengths that are 40 nm apart for a single layer of semiconductor material.

### RELATED APPLICATIONS

This application claims priority under 35 U.S.C. § 119(e) to U.S. Provisional Application Ser. No. 62/813,997, entitled “SEMICONDUCTOR OPTICAL ABSORPTION FILTER FOR AN INTEGRATED DEVICE” filed Mar. 5, 2019 and to U.S. Provisional Application Ser. No. 62/831,237, entitled “SEMICONDUCTOR OPTICAL ABSORPTION FILTER FOR AN INTEGRATED DEVICE” filed Apr. 9, 2019, each of which is herein incorporated by reference in its entirety.

### FIELD

The present application relates to reducing, with an optical absorption filter, unwanted radiation in an integrated device that is used to analyze samples.

### RELATED ART

In the area of instrumentation that is used for analysis of samples, microfabricated chips may be used to analyze a large number of analytes or specimens (contained within one or more samples) in parallel. In some cases, optical excitation radiation is delivered to a plurality of discrete sites on a chip at which separate analyses are performed. The excitation radiation may excite a specimen at each site, a fluorophore attached to the specimen, or a fluorophore involved in an interaction with the specimen. In response to the excitation, radiation may be emitted from a site that is detected by a sensor. Information obtained from the emitted radiation for a site, or lack of emitted radiation, can be used to determine a characteristic of the specimen at that site.

### SUMMARY

Apparatus and methods relating to attenuating excitation radiation or other unwanted radiation incident on a sensor in an integrated device (such as a device used for sample analysis) are described. In some embodiments, a semiconductor film of a selected material and crystal morphology is formed in a stack of materials on a substrate and is located between a waveguide and a sensor in a pixel of an integrated device. The semiconductor material and crystal morphology are selected to significantly attenuate excitation radiation while passing more than 75% of radiation emitted from a reaction chamber in the pixel to the sensor. A wavelength-discrimination ratio (also referred to as “rejection ratio” or “extinction ratio”) greater than 100 or more can be obtained for wavelengths that are separated by 40 nm or approximately 40 nm. In some implementations, a multi-layer stack includes layers of absorbing material separated by layers of dielectric material. The stack may include at least three or four layers having different thicknesses. Such stacks can provide rejection ratios greater than 10,000 over a range of incident angles from normal to 80 degrees (or any sub-range within these angles) for wavelengths that are separated by 110 nm or approximately 110 nm.

Some embodiments relate to a multi-layer semiconductor absorber filter comprising a plurality of layers of semiconductor absorbers and a plurality of layers of dielectric material separating the plurality of semiconductor absorbers to form a multi-layer stack, wherein there are at least three different layer thicknesses within the multi-layer stack.

Some embodiments relate to a method of forming a multi-layer semiconductor absorber filter. A method may comprise acts of depositing a plurality of layers of semiconductor absorbers; and depositing a plurality of layers of dielectric material that separate the plurality of semiconductor absorbers to form a multi-layer stack, wherein at least three different layer thicknesses are deposited within the multi-layer stack.

Some embodiments relate to a fluorescence detection assembly, comprising a substrate having an optical detector formed thereon, a reaction chamber arranged to receive a fluorescent molecule, an optical waveguide disposed between the optical detector and the reaction chamber, and an optical absorption filter comprising a layer of semiconductor material and disposed between the optical detector and the reaction chamber.

Some embodiments relate to an optical absorption filter comprising a semiconductor layer formed over non-planar topography on a substrate.

Some embodiments relate to an optical absorption filter comprising a ternary III-V semiconductor formed in an integrated device on a substrate.

Some embodiments relate to a method for forming a fluorescence detection device, the method comprising: forming an optical detector on a substrate; forming a semiconductor optical absorption filter over the optical detector on the substrate; forming an optical waveguide over the optical detector on the substrate; and forming a reaction chamber configured to receive a fluorescent molecule over the optical absorption filter and the optical waveguide.

The foregoing and other aspects, implementations, acts, functionalities, features and, embodiments of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1-1 depicts an example of structure at a pixel of an integrated device, according to some embodiments.

FIG. 1-2 depicts an example of structure at a pixel of an integrated device, according to some embodiments.

FIG. 1-3 depicts an example of structure at a pixel of an integrated device, according to some embodiments.

FIG. 2-1 illustrates an example semiconductor absorber structure, according to some embodiments.

FIG. 2-2 plots optical transmission as a function of wavelength for a ZnTe semiconductor absorbing layer, according to some embodiments.

FIG. 2-3 plots rejection ratio R, as a function of thickness for an InGaN semiconductor absorbing layer, according to some embodiments.

FIG. 2-4 is a transmission electron micrograph of an example semiconductor absorbing layer.

FIG. 2-5 plots transmission as a function of wavelength for radiation incident on a multi-layer semiconductor absorber, according to some embodiments.

FIG. 2-6A depicts an example of a multi-layer absorber filter, according to some embodiments.

FIG. 2-6B plots another example of transmission as a function of wavelength for radiation incident on a multi-layer semiconductor absorber, according to some embodiments.

FIG. 2-6C plots reflection, absorption, and transmission as a function of angle for s-polarized radiation incident on a multi-layer semiconductor absorber, according to some embodiments.

FIG. 2-7 depicts another example of a multi-layer absorber filter, according to some embodiments.

FIG. 3-1 illustrates an example absorber formed over topography, according to some embodiments.

FIG. 3-2 illustrates an example absorber formed over topography, according to some embodiments.

FIG. 3-3 illustrates an example absorber formed over topography, according to some embodiments.

FIG. 3-4A depicts patterned resist layers that can be used to form a semiconductor absorber over topography, according to some embodiments.

FIG. 3-4B illustrates structure associated with forming a semiconductor absorber over topography, according to some embodiments.

FIG. 3-4C illustrates structure associated with forming a semiconductor absorber over topography, according to some embodiments.

FIG. 3-4D illustrates structure associated with forming a semiconductor absorber over topography, according to some embodiments.

FIG. 3-4E illustrates structure associated with forming a semiconductor absorber over topography, according to some embodiments.

FIG. 4 depicts a cutaway perspective view of a portion of an integrated device, according to some embodiments.

FIG. 5-1A is a block diagram depiction of an analytical instrument that includes a compact mode-locked laser module, according to some embodiments.

FIG. 5-1B depicts a compact mode-locked laser module incorporated into an analytical instrument, according to some embodiments.

FIG. 5-2 depicts a train of optical pulses, according to some embodiments.

FIG. 5-3 depicts an example of parallel reaction chambers that can be excited optically by a pulsed laser via one or more waveguides and further shows corresponding detectors for each chamber, according to some embodiments.

FIG. 5-4 illustrates optical excitation of a reaction chamber from a waveguide, according to some embodiments.

FIG. 5-5 depicts further details of an integrated reaction chamber, optical waveguide, and time-binning photodetector, according to some embodiments.

FIG. 5-6 depicts an example of a biological reaction that can occur within a reaction chamber, according to some embodiments.

FIG. 5-7 depicts emission probability curves for two different fluorophores having different decay characteristics.

FIG. 5-8 depicts time-binning detection of fluorescent emission, according to some embodiments.

FIG. 5-9 depicts a time-binning photodetector, according to some embodiments.

FIG. 5-10A depicts pulsed excitation and time-binned detection of fluorescent emission from a reaction chamber, according to some embodiments.

FIG. 5-10B depicts a histogram of accumulated fluorescent photon counts in various time bins after repeated pulsed excitation of an analyte, according to some embodiments.

FIG. 5-11A-5-11D depict different histograms that may correspond to the four nucleotides (T, A, C, G) or nucleotide analogs, according to some embodiments.

The features and advantages of the present invention will become more apparent from the detailed description set forth below when taken in conjunction with the drawings. When describing embodiments in reference to the drawings, directional references (“above,” “below,” “top,” “bottom,” “left,” “right,” “horizontal,” “vertical,” etc.) may be used. Such references are intended merely as an aid to the reader viewing the drawings in a normal orientation. These directional references are not intended to describe a preferred or only orientation of features of an embodied device. A device may be embodied using other orientations.

### DETAILED DESCRIPTION

I. Integrated Device with a Semiconductor Absorber

Instruments for analyzing samples continue to improve and may incorporate microfabricated components (e.g., electronic chips, microfluidic chips) which can help reduce the overall size of the instrument. Samples to be analyzed can include air (e.g., sensing for harmful gaseous leaks, combustion by-products, or toxic chemical components), water or other ingestible liquids, food samples, and biological samples taken from subjects (blood, urine, etc.) In some cases, it is desirable to have portable, hand-held instruments for analyzing samples, so that technicians or medical personnel can easily carry the instrument into the field where service may be performed and a sample needs to be analyzed quickly and accurately. In clinical settings, a desk-top size instrument may be desired for more complex sample analysis such as sequencing of human genes or complete blood count analysis.

In an advanced analytic instrument, such as those described in U.S. Patent Publication No. 2015/0141267 and in U.S. Pat. No. 9,617,594, both of which are incorporated herein by reference, a disposable integrated device (which may be referred to as “chip” and “disposable chip” for brevity) may be used to perform massively parallel sample analyses. The disposable integrated device may comprise a packaged bio-optoelectronic chip on which there can be a large number of pixels having reaction chambers for parallel analyses of one sample or of different samples. For example, the number of pixels having reaction chambers on a bio-optoelectronic chip can be between about 10,000 and about 10,000,000 in some cases, and between 100,000 and about 100,000,000 in some cases. In some embodiments, the disposable chip may mount into a receptacle of an advanced analytic instrument and interface with optical and electronic components in the instrument. The disposable chip can be replaced easily by a user for each new sample analysis.

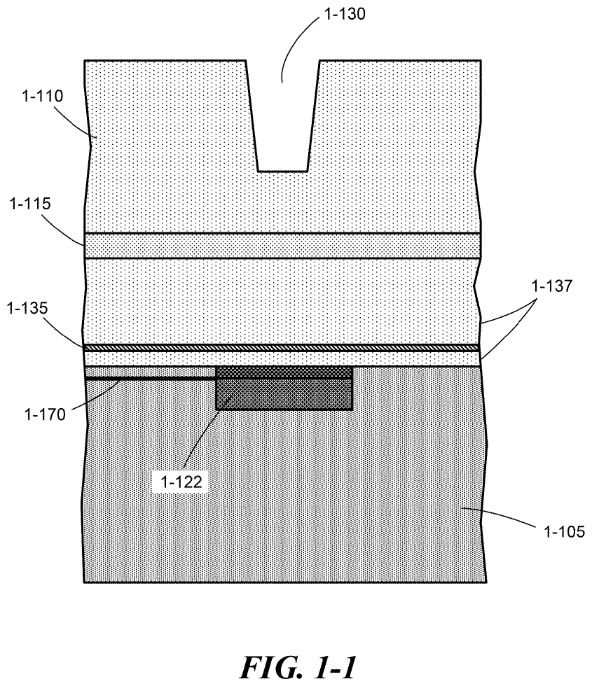

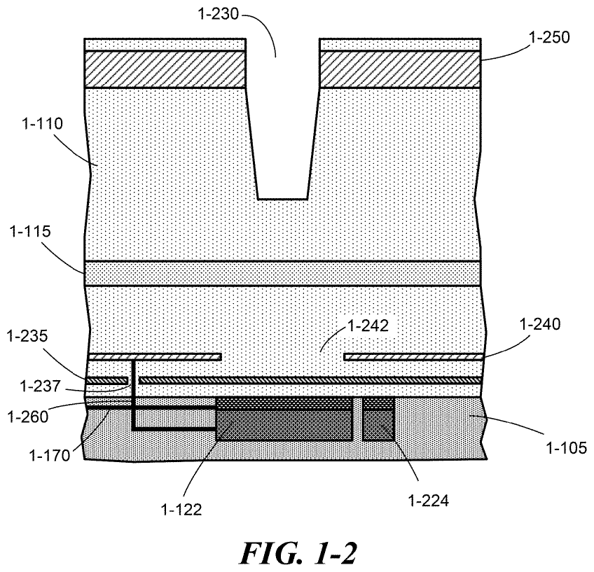

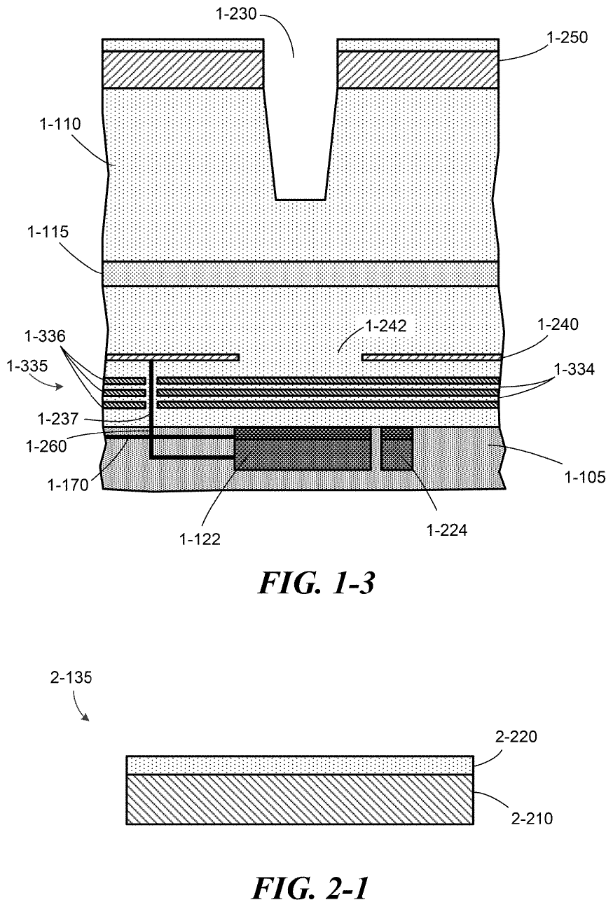

FIG. 1-1 is a simplified drawing that depicts some components that may be included in a pixel of bio-optoelectronic chip. A pixel can include a reaction chamber 1-130, an optical waveguide 1-115, a semiconductor absorber 1-135, and a sensor 1-122 formed on a substrate 1-105. The waveguide 1-115 can transport optical energy to the pixel from a remote optical source and provide excitation radiation to the reaction chamber 1-130. The excitation radiation may excite one or more fluorophores present in the reaction chamber 1-130. Emitted radiation from the fluorophore(s) can be detected by sensor 1-122. A signal, or lack thereof, from the sensor 1-122 can provide information about the presence or absence of an analyte in the reaction chamber 1-130. In some implementations, a signal from the sensor 1-122 can identify the type of analyte present in the reaction chamber.

For sample analysis, a sample containing one or more analytes may be deposited over the reaction chamber 1-130. For example, a sample may be disposed in a reservoir or microfluidic channel over the reaction chamber 1-130. In some cases, a sample may be printed as a droplet onto a treated surface that includes the reaction chamber 1-130. During sample analysis, at least one analyte from a sample to be analyzed may enter the reaction chamber 1-130. In some implementations, the analyte itself may fluoresce when excited by excitation radiation delivered from the waveguide 1-115. In some cases, the analyte may carry with it one or more linked fluorescent molecules. In yet other cases, the analyte may quench a fluorophore already present in the reaction chamber 1-130. When the fluorescing entity enters into the reaction chamber and is excited by excitation radiation, the fluorescing entity can emit radiation, at a different wavelength than the excitation radiation, that is in turn detected by the sensor 1-122. The semiconductor absorber 1-135 can preferentially attenuate excitation radiation significantly more than emission radiation from the reaction chamber 1-130.

In further detail, reaction chamber 1-130 may be formed into a transparent or semitransparent layer 1-110. The reaction chamber may have a depth between 50 nm and 1 μm, according to some embodiments. A minimum diameter of the reaction chamber 1-130 may be between 50 nm and 300 nm in some embodiments. If the reaction chamber 1-130 is formed as a zero-mode waveguide, then the minimum diameter may be even less than 50 nm in some cases. If large analytes are to be analyzed, the minimum diameter may be larger than 300 nm. The reaction chamber may be located above the optical waveguide 1-115 such that a bottom of the reaction chamber may be up to 500 nm above a top of the waveguide 1-115. In some cases, the bottom of the reaction chamber 1-130 may be located within the waveguide or on a top surface of the waveguide 1-115. The transparent or semitransparent layer 1-110 can be formed from an oxide or a nitride, according to some embodiments, so that excitation radiation from the optical waveguide 1-115 and emission radiation from the reaction chamber 1-130 will pass through the transparent or semitransparent layer 1-110 without being attenuated by more than 10%, for example.

In some implementations, there can be one or more additional transparent or semitransparent layers 1-137 formed on the substrate 1-105 and located between the substrate and the optical waveguide 1-115. These additional layers may be formed from an oxide or a nitride, and may be of the same type of material as the transparent or semitransparent layer 1-110, in some implementations. The semiconductor absorber 1-135 may be formed within these additional layers 1-137 between the waveguide 1-115 and sensor 1-122. A distance from the bottom of the optical waveguide 1-115 to the sensor 1-122 can be between 500 nm and 10 μm.

In various embodiments, the substrate 1-105 may comprise a semiconductor substrate, such as silicon (Si). However, other semiconductor materials may be used in some embodiments. The sensor 1-122 may comprise a semiconductor photodiode that is patterned and formed on the substrate 1-105. The sensor 1-122 may connect to other complementary metal-oxide-semiconductor (CMOS) circuitry on the substrate via interconnects 1-170.

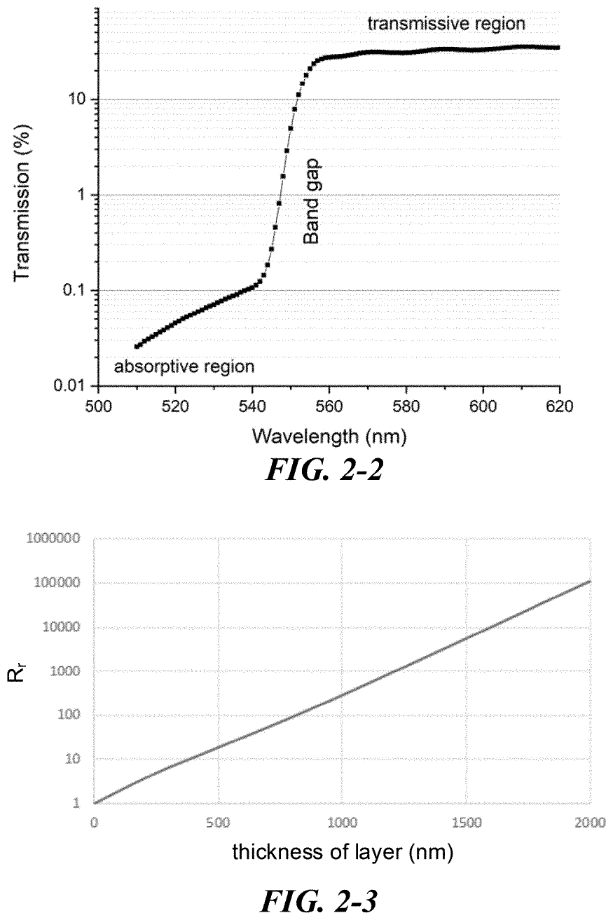

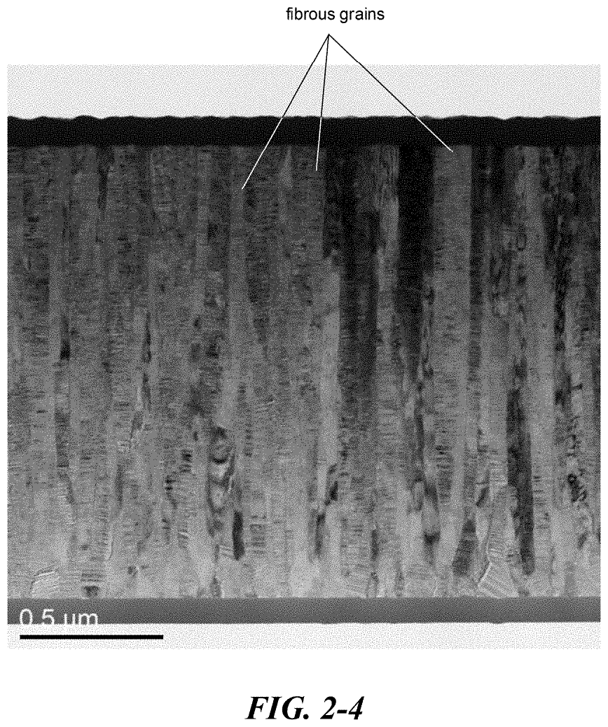

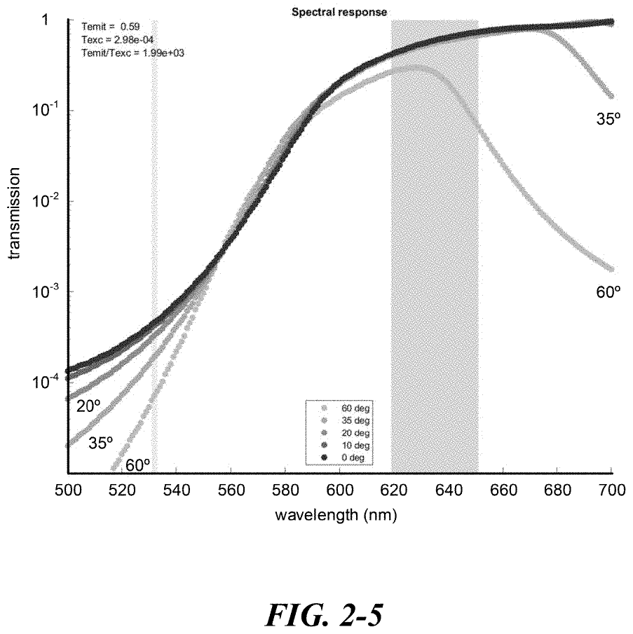

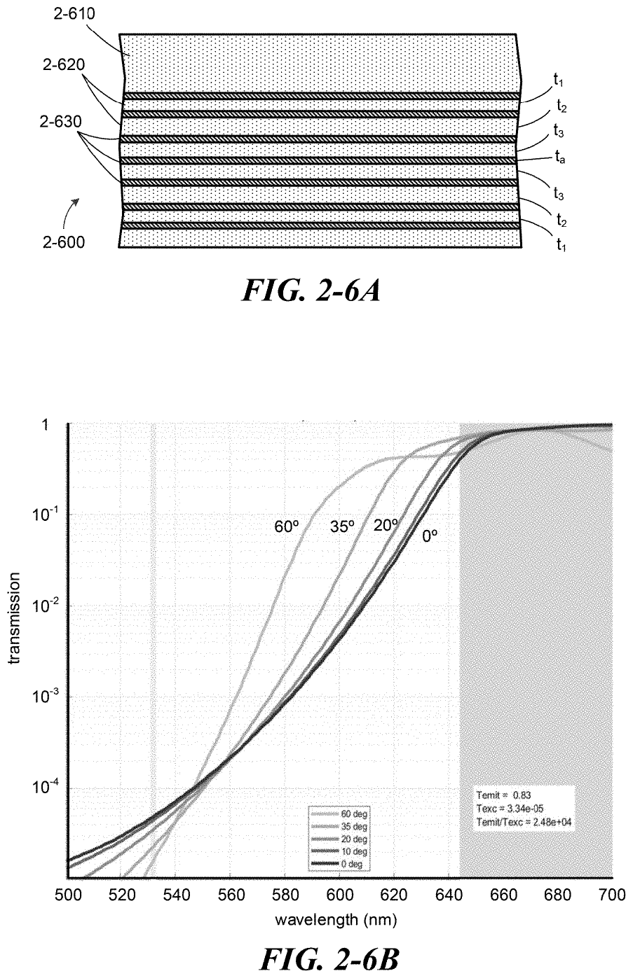

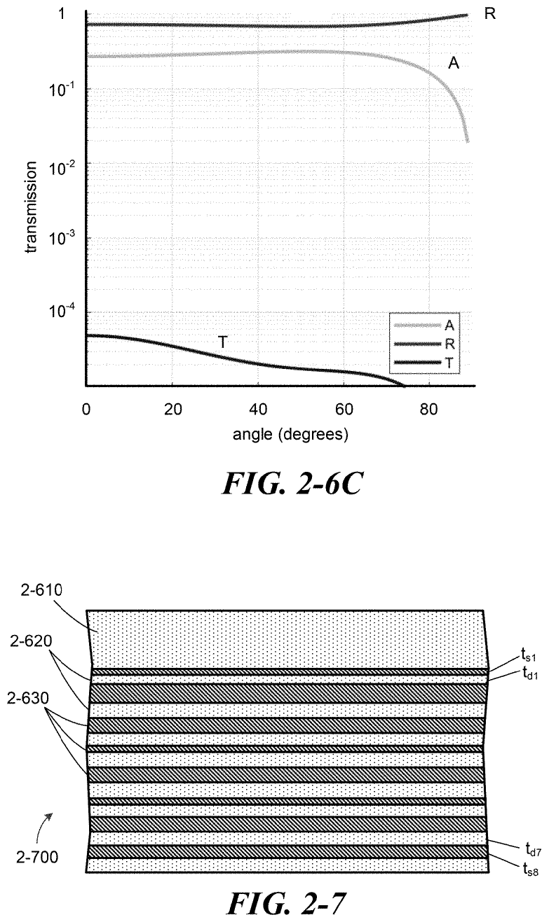

Another example of structure that may be included at a pixel of an integrated device is shown in FIG. 1-2. According to some implementations, one or more light-blocking layers 1-250 may be formed over layer 1-110, into which a reaction chamber 1-230 may be formed.

In some implementations, a process of etching of the reaction chamber may begin with opening an aperture in the one or more light-blocking layers that will become a top of the reaction chamber 1-230. The light-blocking layers 1-250 may be formed from one or more metal layers. In some cases, the light-blocking layers 1-250 may include a semiconductor and/or oxide layer. The light-blocking layers 1-250 may reduce or prevent excitation radiation from the optical waveguide 1-115 from travelling into a sample above the reaction chamber 1-230 and exciting analytes within the sample. Additionally, the light-blocking layers 1-250 can prevent external radiation from above the reaction chamber to pass through to the sensor 1-122. Emission from outside the reaction chamber can contribute to unwanted background radiation and signal noise.

In some embodiments, one or more iris layers 1-240 may be formed above the sensor 1-122. An iris layer 1-240 may include an opening 1-242 to allow emission from the reaction chamber 1-230 to pass through to the sensor 1-122, while blocking emission or radiation from other directions (e.g., from adjacent pixels or from scattered excitation radiation). For example, the iris layer 1-240 may be formed from a light-blocking material that can block scattered excitation radiation at wide angles of incidence from striking the sensor 1-122 and contributing to background noise.

In some cases, an iris layer 1-240 may be formed from a conductive material and provide a potential reference plane or grounding plane for circuitry formed on or above the substrate 1-105. According to some implementations, a via or hole 1-237 may be formed in the semiconductor absorber 1-235 (and capping layers, if present, that contact the semiconductor absorbing layer) so that a vertical conductive interconnect or via 1-260 may connect to the iris layer 1-240 without contacting the semiconductor absorber 1-235, which may be conductive. In some cases, the semiconductor absorber 1-235 may be used as a potential reference plane or grounding plane for circuitry formed on or above the substrate 1-105, and a vertical interconnect may connect to the semiconductor absorber 1-235 and may not connect to the iris layer 1-240. In some cases, the hole 1-237 may include electrically insulating material (e.g., an oxide) that prevents electrical contact between a conductive via 1-260 and the semiconductor absorbing layer 1-235. In some implementations, the semiconductor absorbing layer 1-235 may have high resistivity and the hole 1-237 may be filled with conductive material to provide an electrical connection through the semiconductor absorbing layer. In embodiments, there may be additional electronic components, such as storage and read-out electronics 1-224 formed with the sensor on the substrate 1-105 at each pixel. The read-out electronics may be used to control signal acquisition and to read out stored charges at each sensor 1-122, for example. In some embodiments, a hole 1-237 in the semiconductor absorber 1-235 (and capping layers) can facilitate electrical connection through the semiconductor layer, e.g., connection of an integrated circuit to an external circuit, via wire bonding, flip-chip bonding, or other methods.

In some cases, there may be multiple layers of semiconducting absorbing material, as depicted in FIG. 1-3. For example, a semiconductor absorber 1-335 may comprise two, three, or more layers of semiconductor absorbing material 1-336 that are spaced apart by intervening layers 1-334 of material. The intervening layers 1-334 can have a different index of refraction than the semiconductor absorbing material 1-336. The intervening layers 1-334 can additionally or alternatively have a different transmissivity than the semiconductor absorbing material 1-336. In some cases, the thickness of the different layers of semiconductor absorbing material 1-336 are essentially the same, and may be different from the thicknesses of the intervening layers 1-334, though in some cases the layers of semiconductor absorbing material 1-336 may have at least two different thicknesses. In some embodiments, the thicknesses of the semiconductor absorbing material 1-336 may be between 75 nm and 90 nm for silicon-based absorbing material and an excitation characteristic wavelength between 515 nm and 540 nm. Other thicknesses may be used for other absorbing materials and excitation wavelengths. In some cases, the thickness of the intervening layers 1-334 are essentially the same, and may be different from the thicknesses of the layers of semiconductor absorbing material 1-336, though in some cases the intervening layers 1-334 may have at least two different thicknesses. In some embodiments, the thicknesses of the intervening layers 1-334 may be between 50 nm and 150 nm for silicon oxide and an excitation characteristic wavelength between 515 nm and 540 nm. Other thicknesses may be used for other intervening layer materials and excitation wavelengths.

By using multiple layers of semiconductor absorbing material 1-336 as depicted in FIG. 1-3, optical interference effects between layers may effectively sharpen an abruptness of a band-edge of the semiconductor absorber and improve a rejection ratio for the semiconductor absorber 1-335. Interferometric sharpening of the band-edge may allow lower-quality crystallinity of the semiconductor absorbing material 1-336. In some implementations, polycrystalline or amorphous semiconductor material (e.g., amorphous silicon, amorphous silicon carbide, amorphous ZnTe, amorphous InGaN, etc.) may be used in a semiconductor absorber 1-335 having multiple layers of semiconductor absorbing material 1-336.

Further details of a semiconductor absorber 2-135 are shown in FIG. 2-1. In various embodiments, a semiconductor absorber 2-135 comprises a semiconductor absorbing layer 2-210. The structure shown in FIG. 2-1 may be implemented in a semiconductor absorber having only one layer of semiconducting absorbing material, or may be used for one or more layers in a semiconductor absorber having multiple layers of semiconducting absorbing material. The semiconductor absorbing layer may be formed from a semiconductor material having a band gap. For example, the semiconductor absorbing layer may be formed from compound semiconductor materials having a bandgap corresponding to the visible range of the optical spectrum. Example materials include, but are not limited to, zinc telluride, indium-gallium nitride, gallium phosphide, vanadium oxide, tantalum nitride, aluminum arsenide, magnesium silicide, aluminum antimonide, silicon arsenide, and indium arsenide. Additional materials that may be suitable for some applications include silicon carbide, silicon carbon hydrogen, cadmium sulfide, cadmium oxide, and zinc selenide. Such example materials may be implemented with various stoichiometric ratios. The semiconductor absorbing layer 2-210 may be polycrystalline in some embodiments, or may be single crystalline in some embodiments. In some cases, an average grain size for a polycrystalline semiconductor absorbing layer 2-210 may be no smaller than 20 nm, measured in a lateral, in-plane direction. In some cases, an average grain size for a polycrystalline semiconductor absorbing layer 2-210 may be no smaller than 1 μm, measured in a lateral, in-plane direction. In some embodiments, the semiconductor absorbing layer 2-210 may comprise amorphous semiconductor material. A thickness of the semiconductor absorbing layer 2-210 may be between 200 nm and 5 μm, according to some embodiments. In some cases, a thickness of the semiconductor absorbing layer 2-210 may be between 1 μm and 2 μm.

The type of semiconductor material used for the semiconductor absorbing layer 2-210 can be selected or tailored to provide a desired absorption for the excitation radiation and transmission for radiation emitted from the reaction chamber 1-230. For example, a semiconductor material may be selected or tailored to have a bandgap, such that excitation radiation having photon energies greater than the bandgap will be mostly absorbed by the semiconductor material and fluorophore emission from the reaction chamber 1-230 having photon energies less than the bandgap will be mostly transmitted by the semiconductor material. In embodiments, the bandgap is chosen or tailored such that the transition between wavelengths that are absorbed and wavelengths that are transmitted lies between excitation radiation provided by the optical waveguide 1-115 and fluorescence emission emitted from the reaction chamber 1-230. The bandgap of a semiconductor absorbing layer 2-210 may be tailored by changing the composition of a semiconductor (e.g., changing the stoichiometric ratio of In and Ga in InₓGa₁₋ₓN where x ranges in value according to 0<x<1).

An example transmission curve for a semiconductor absorbing layer 2-210 formed from ZnTe is shown in FIG. 2-2. In some embodiments, excitation radiation may have a characteristic wavelength of 532 nm, and fluorescent emission may have a characteristic wavelength value lying between 560 nm and 580 nm. For the example shown in which the excitation radiation has a characteristic wavelength of approximately 532 nm, the semiconductor absorbing layer 2-210 transmits approximately 400 times more emission radiation (toward the sensor 1-122, for example) than excitation radiation (a rejection ratio Rᵣ˜400). In some implementations, the excitation radiation may have a characteristic wavelength between 500 nm and 540 nm and the emission radiation may have a characteristic wavelength between 560 nm and 650 nm. In some cases, the rejection ratio can be higher (e.g., between 400 and 800, between 800 and 1000, or between 1000 and 3000) According to some embodiments, a semiconductor absorber may attenuate the desired detected radiation (e.g., the emission radiation from the reaction chamber) between 5% and 85% while attenuating the unwanted radiation significantly more than this amount.

The inventors have recognized and appreciated that the abruptness of the filter cut-off and ratio of transmitted radiation at wavelengths longer than the cut-off to absorbed radiation at wavelengths shorter than the cut-off depends on thickness of the semiconductor absorbing layer(s) 2-210, number of semiconductor absorbing layers, crystal quality of the semiconductor absorbing layer(s), and separation of excitation and emission characteristic wavelengths and that each of these parameters can be modified to some extent. The thickness of a semiconductor absorbing layer 2-210 can be controlled by adjusting the length of a deposition time for the semiconductor absorbing material, for example.

In some implementations, a type of deposition process may be selected (e.g., metal-organic chemical vapor deposition, molecular beam epitaxy, or physical vapor deposition) to improve crystal quality of the semiconductor absorbing layer 2-210. In some cases, a seed layer of a different material may be deposited first on an underlying layer to improve the crystal quality of a subsequently deposited semiconductor absorbing layer 2-210. In some implementations, a post-deposition anneal step can be carried out to improve the crystal quality of a semiconductor absorbing layer 2-210. In some embodiments, a semiconductor absorbing layer 2-210 may have an average crystal grain size, as measured in the plane of the layer, that is no smaller than 20 nm. In some cases, the average crystal grain size is no smaller than 50 nm. In some cases, the average crystal grain size is no smaller than 100 nm. In some cases, the average crystal grain size is no smaller than 500 nm. In some cases, the average crystal grain size is between 40 nm and 100 nm. In some cases, the average crystal grain size is between 100 nm and 500 nm. In some cases, the average crystal grain size is between 100 nm and 1 μm. In some cases, the average crystal grain size is between 1 μm and 3 μm. In some cases, the average crystal grain size is between 2 μm and 5 μm. In some cases, the average crystal grain size is between 5 μm and 10 μm. According to some implementations, the semiconductor absorbing layer 2-210 may have larger crystal grain sizes or may be essentially single crystal. For example, the semiconductor absorbing layer 2-210 may be delaminated and transferred from a single-crystal wafer as grown using a handle wafer, and deposited by bonding to an underlying layer on the substrate 1-105.

In some implementations, the semiconductor absorbing layer 2-210 may have a particular crystalline morphology, such as fibrous, cylindrical, or pancake. A fibrous morphology may exhibit fiber-like or tall columnar crystals oriented vertically in the semiconductor absorbing layer 2-210. An example of fibrous crystals is shown in the transmission-electron microscope image of FIG. 2-4. The long columnar crystals have high aspect ratios (e.g., a length-to-diameter ratio greater than 10:1) and are oriented vertically and formed within a layer of zinc telluride. Cylindrical morphology may have crystal grains with length-to-diameter ratios between 0.5:1 and 10:1. Pancake morphology may have crystal grains with length-to-diameter ratios less than 0.5:1.

In some cases, a semiconductor absorbing layer 2-210 may be formed from amorphous semiconductor material. For example, any of the semiconductor materials described herein may be deposited as amorphous material by sputtering, e-beam evaporation, or a chemical vapor deposition process, such as plasma-enhanced chemical vapor deposition (PECVD). Example amorphous semiconductor materials include, but are not limited to, amorphous silicon, amorphous silicon carbide, amorphous silicon nitride, amorphous silicon oxide, amorphous ZnTe, amorphous InGaN, and alloys thereof. In some implementations, an amorphous semiconductor material or alloy may be hydrogenated (e.g., amorphous hydrogenated silicon, amorphous hydrogenated silicon carbide, etc.) In some implementations, nitrogen may be added to an amorphous semiconductor material or alloy during deposition, e.g., during a chemical vapor deposition process. In some cases, nitrogen and/or other element(s) can be added to a material during deposition, such as amorphous silicon, to tune the refractive index n and extinction coefficient k to values desired for transmitting and blocking wavelengths of interest. In some embodiments, a deposited amorphous semiconductor material may include nanocrystals or microcrystals distributed throughout the amorphous semiconductor material. An amorphous semiconductor absorbing layer 2-210 may be used in any of the semiconductor absorber structures described herein. In practice, an amorphous semiconductor absorbing layer 2-210 may be easier and less costly to fabricate on a substrate with existing foundry tools and processes. In some cases, deposition of an amorphous semiconductor or other material may be achieved at lower temperatures (e.g., less than 500° C.) that are compatible with a CMOS process, for example. Although an amorphous semiconductor material may not provide a band-edge that is as abrupt as a polycrystalline or crystalline semiconductor material of the same type, the band-edge may be sufficient when there is a large difference in characteristic excitation and emission wavelengths. However, some microfabrication processes may enable polycrystalline or crystalline semiconductor materials to be used in a way that is compatible with CMOS structures.

An advantage of an absorbing layer, such as a semiconductor absorbing layer 2-210, is that it can have a higher angular tolerance than other types of wavelength filters, such as multilayer dielectric filters. In a dielectric filter, the layers each absorb negligible amounts of radiation (e.g., less than one percent of incident radiation). For example, a multilayer dielectric filter (such as a distributed Bragg reflector) with thickness of about 2 microns can provide a rejection ratio Rᵣ of approximately 800 at normal incidence. The rejection ratio Rᵣ is a ratio of transmitted intensity at an emission wavelength (572 nm for an example structure) to transmitted intensity at an excitation wavelength (532 nm for the example structure). At 30 degrees angle of incidence, the rejection ratio Rᵣ drops to 110. In contrast, a 2.0-micron-thick, ZnTe semiconductor absorbing layer 2-210 provides a rejection ratio Rᵣ of exceeding 800 at all angles of incidence. Accordingly, a micron-scale, thin film, absorbing layer or semiconductor absorbing layer 2-210 can outperform a micron-scale, thin film, multilayer dielectric filter in terms of angular tolerance, and additionally be compatible with widely available CMOS processing equipment. For example, a semiconductor absorbing layer 2-210 may comprise one or a few layers that may not have as tight dimensional tolerances required for a multilayer dielectric filter.

According to some embodiments, a semiconductor absorbing layer 2-210 may be formed from InGaN which can provide tunability of the bandgap over a broad range. For example, by varying the ratio of concentrations of In and Ga, the bandgap can be tuned from 0.8 eV to 3.4 eV, covering the entire visible wavelength range. InGaN can be grown epitaxially as single crystal material on a crystalline substrate, or may be deposited in polycrystalline form by various chemical and physical deposition methods, including metallorganic chemical vapor deposition (MOCVD), molecular beam epitaxy (MBE), sputtering, reactive sputtering, and other established methods. In some implementations, a bandgap may be tuned by alloying or otherwise combining a binary semiconductor with a third group II and/or group VI element. Some example resulting ZnTe semiconductor compositions include, but are not limited to, ZnTeO and CdZnTe.

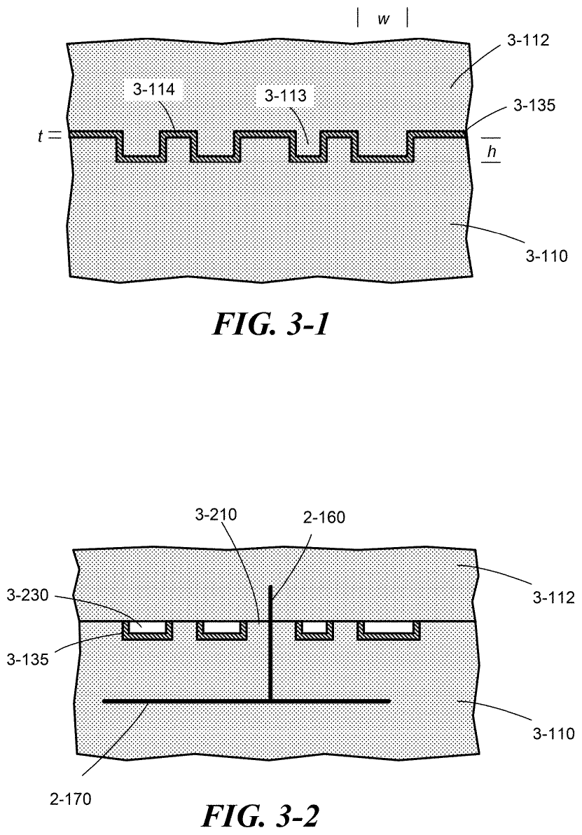

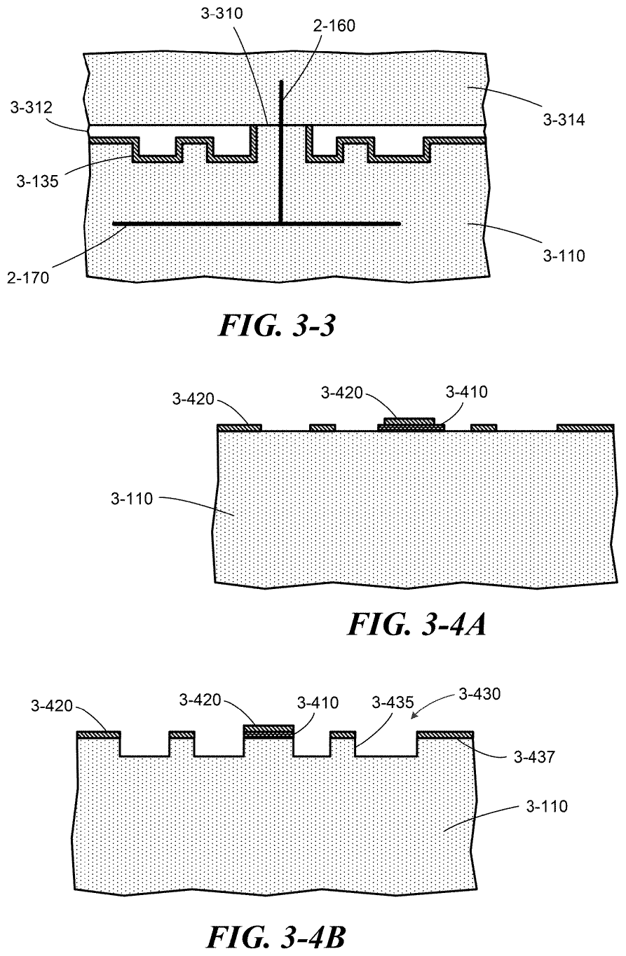

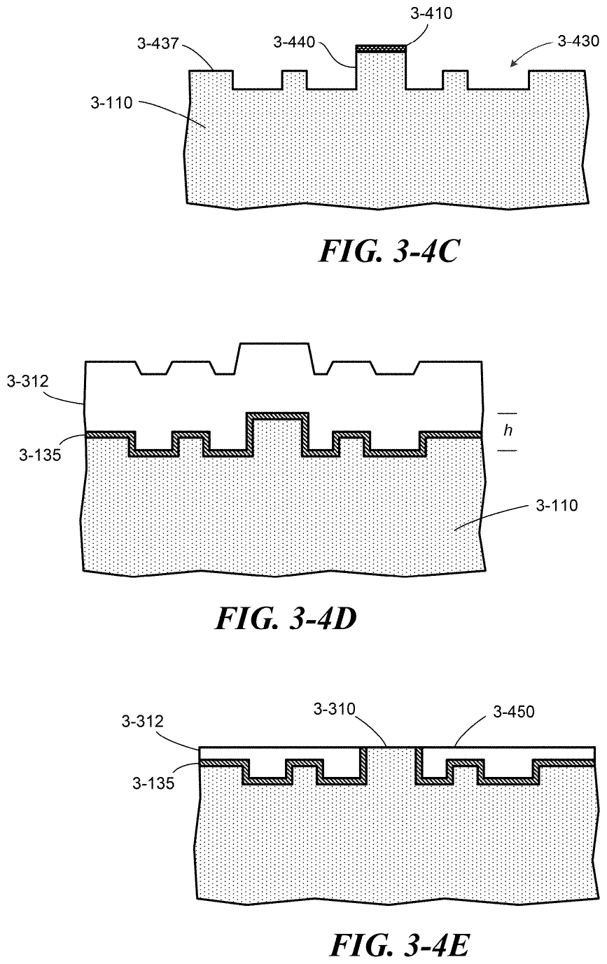

Modelling of single-crystal InGaN suggests that a rejection ratio Rᵣ (572 nm/532 nm) greater than 3000 can be obtained for a layer thickness of 1.5 microns. In some embodiments, a semiconductor absorber 2-135 may comprise a semiconductor absorbing layer 2-210 formed from InGaN. A thickness of the absorbing layer may be between 200 nm and 3 microns, and a rejection ratio Rᵣ for the layer may be between 20 and 100,000. An example curve of rejection ratio Rᵣ calculated for single-crystal InGaN as a function of layer thickness is plotted in FIG. 2-3.

In some embodiments, one or more capping layers 2-220 may be formed adjacent to the semiconductor absorbing layer 2-210. In some cases, there may be one capping layer 2-220 on one side of the semiconductor absorbing layer 2-210. In other cases there may be a capping layer on each side of the semiconductor absorbing layer 2-210, for example top and bottom sides. A capping layer 2-220 may comprise at least one thin layer between 20 nm and 100 nm thick, according to some embodiments, though thicker layers may be used in some cases. In some implementations, a capping layer 2-220 on one side of the semiconductor absorbing layer 2-210 may comprise plural layers of different materials. Example materials that can be used for the capping layer 2-220 include, but are not limited to, silicon nitride, aluminum oxide, titanium oxide, hafnium oxide, and tantalum oxide.

One or more capping layers 2-220 may be included to prevent diffusion of the semiconductor absorbing layer 2-210 into adjacent material or to prevent release of the semiconductor absorbing material into an environment. In some implementations, a capping layer 2-220 may additionally or alternatively provide improved adhesion to an immediately adjacent layer than would be provided by the semiconductor absorbing layer 2-210 alone. In some implementations, one or more capping layers 2-220 can reduce or induce stresses in the semiconductor absorbing layer 2-210 and/or improve crystallinity of the semiconductor absorbing layer 2-210. In some cases, a capping layer 2-220 may reduce stress from the semiconductor absorbing layer 2-210 in the assembly by providing a compensating type of stress (e.g., tensile stress if the semiconductor absorbing layer has compressive stress).

Additionally or alternatively, in some embodiments, a capping layer may be formed to reduce optical reflections from the semiconductor absorbing layer 2-210. In some cases, the semiconductor absorbing layer 2-210 may have a significantly different index of refraction than the adjacent layers, which can cause an appreciable amount of reflected radiation from the interface between the semiconductor absorbing layer 2-210 and an adjacent layer. In this regard, one or more capping layers 2-220 may formed as anti-reflection coating(s) for the semiconductor absorbing layer 2-210, and reduce optical reflections one or more wavelengths over a range of wavelengths. For example, a capping layer 2-220 may reduce reflection of emission radiation from the reaction chamber 1-230 and/or of excitation radiation. For a semiconductor absorbing layer 2-210 formed from ZnTe and having adjacent silicon oxide layers, the reflections at 532 nm and 572 nm can be approximately 14% and 10%, respectively. Adding a capping layer 2-220 of silicon nitride, 63 nm thick, can reduce these reflections to less than 1%. According to some embodiments, an oxide or nitride capping layer formed adjacent to the semiconductor absorbing layer reduces optical reflection from the semiconductor absorbing layer for a visible wavelength between 500 nm and 750 nm compared to a case where the oxide or nitride capping layer is not present. A thickness of the oxide or nitride capping layer can be chosen to reduce the optical reflection for the desired wavelength.

According to some implementations, a semiconductor absorbing layer 2-210 may be incorporated by itself, or with one or more capping layers 2-220, into a stack that includes one or more dielectric layers having different optical properties than the semiconductor absorbing layer 2-210, as depicted in FIG. 1-3 for example. The thicknesses of the one or more dielectric layers, semiconductor absorbing layer 2-210, and one or more capping layers 2-220 (if present) may be selected to provide optical interference of the excitation radiation and/or emission radiation. As such, the semiconductor absorbing layer 2-210 and one or more dielectric layers can form a hybrid absorptive-interference filter that may further increase a rejection ratio Rᵣ for the stack compared to a rejection ratio Rᵣ for a semiconductor absorber 1-235 alone. In some cases, such a multi-layer stack may comprise one or more semiconductor absorbing layers 2-210 that are formed from polycrystalline or amorphous semiconductor material. In some cases, a multi-layer stack may comprise one or more absorbing layers that are formed from polycrystalline or amorphous material that is not a semiconductor.

The inventors have further recognized and appreciated that emission radiation may be shifted to a longer wavelength using Dexter energy transfer (DET) and/or Førster resonant energy transfer (FRET) processes. As an example, there may be two fluorophores associated with an analyte or specimen. A first of the two fluorophores may be excited more efficiently by excitation radiation delivered to a reaction chamber than the second fluorophore. The second fluorophore may be attached with a chemical linker so that it is in close proximity (e.g., less than 10 nm) from the first fluorophore. As such, emission energy from the first fluorophore may transfer from the first fluorophore to the second fluorophore and excite the second fluorophore so that it emits radiation at a longer characteristic wavelength than the first fluorophore and is detected by a sensor 1-122. As an example, the first fluorophore may emit with a characteristic wavelength that is within the yellow region of the optical spectrum, and the second fluorophore may emit with a characteristic wavelength that is red-shifted, e.g., within the yellow-red or red region of the optical spectrum. The energy transfer from the first fluorophore to the second fluorophore may be a non-radiative DET or FRET process in some cases. The energy transfer and shift of emission radiation to a longer characteristic wavelength results in an effective Stokes shift that is larger than a Stokes shift for a single fluorophore. Such an increased effective Stokes shift may move the emission radiation farther from the band-edge of a semiconductor absorber to a location where absorption of the emission wavelength by the semiconductor absorber is less than it would be for the first fluorophore.

In general, it is desirable to use a fluorophore with a large separation between excitation wavelength and emission wavelength. For a single electronic transition in a fluorophore, this separation is referred to as the “Stokes shift.” In some embodiments, multiple fluorophores may be used as described above in a FRET or DET approach to achieve a larger separation between excitation wavelength and emission wavelength. This larger separation between excitation wavelength and emission wavelength resulting from the use of multiple fluorophores is referred to herein as an “effective Stokes shift.”

FIG. 2-5 plots calculated transmission results for a multi-layer semiconductor absorber as a function of wavelength for five different angles of incidence. The multi-layer semiconductor absorber consists of four layers of amorphous silicon, each approximately 85 nm thick, separated by three layers of silicon oxide, each approximately 110 nm thick. The multi-layer semiconductor absorber is embedded in silicon oxide. The index of refraction of the amorphous silicon is approximately 4.3 at a wavelength of 532 nm with a value that depends upon the wavelength of radiation, and the index of refraction of the silicon oxide is approximately 1.5 at a wavelength of 532 nm with a value that also depends upon the wavelength of the radiation incident on the semiconductor absorber. For this calculation, the excitation radiation has a characteristic wavelength of approximately 532 nm, and two fluorophores are used as described above to shift the emission characteristic wavelength to a value in a range between 620 nm and 690 nm. The calculation shows that a rejection ratio greater than 1000 can be obtained with a multi-layer semiconductor absorber.

The results plotted in FIG. 2-5 also indicate that the rejection ratio is maintained or even higher, in some cases, for non-normal angles of incidence. This behavior is unlike the angular dependence of a multi-layer dielectric bandpass filter, for which the rejection ratio can significantly decrease for non-normal angles of incidence. Maintaining high rejection ratios over large angles of incidence can be advantageous in an integrated device that includes a plurality of pixels. For example, a filter having high rejection ratios over large angles of incidence can allow pixels to be packed more closely together, since the filter can better block or reduce oblique radiation from adjacent pixels that would otherwise be detected by a sensor 1-122 as crosstalk noise.

In some cases, maintaining only a high rejection of excitation radiation at large non-normal angles of incidence can be sufficient for increasing pixel density. For example, in FIG. 2-5 excitation radiation having a characteristic wavelength of 532 nm is increasingly rejected at non-normal angles up to 60 degrees or higher. This behavior can improve rejection of excitation radiation from adjacent pixels. In some implementations, a semiconductor absorber that increases rejection of emission radiation at large non-normal angels of incidence can further be beneficial. The results of FIG. 2-5 indicate that emission radiation at 60 degrees is attenuated more than emission radiation at 35 degrees. This behavior can improve rejection of emission radiation from adjacent pixels. According to some embodiments, center-to-center pixel spacing for a plurality of pixels in an integrated device may have a value in a range between 2 microns and 50 microns, though smaller or larger spacings may be possible in some cases.

Another example of a multi-layer semiconductor absorber filter 2-600 is depicted in FIG. 2-6A. A semiconductor absorber filter 2-600 may include a plurality of layers of semiconductor absorbers 2-630 that are separated by a plurality of layers of dielectric material 2-620. In the illustrated example, the multi-layer semiconductor absorber filter 2-600 comprises seven layers or thin films of semiconductor absorbers 2-630 that are separated by six layers of dielectric material 2-620. The layers of semiconductor absorbers 2-630 may absorb significantly more radiation (e.g., at least twice as much radiation) as the layers of dielectric material 2-620. As an example, the semiconductor absorbers 2-630 can be formed from nitrogen-doped amorphous silicon and the layers of dielectric material 2-620 can comprise an oxide, such as silicon dioxide. “Doping” in this context refers to adding an impurity to adjust the optical properties (e.g., refractive index, extinction coefficient) of the absorber. The multi-layer semiconductor absorber filter 2-600 can further be integrated in a stack of surrounding materials 2-610, 2-640 on a substrate. The surrounding materials may be the same material as or different materials than the layers of dielectric material 2-620. In some implementations, fewer or more layers of semiconductor absorbers 2-630 may be used than illustrated in FIG. 2-6A.

Although the example filter depicted in FIG. 2-6A comprises a semiconductor absorber, other materials may be used in other embodiments. For example, doped glasses, oxides, or nitrides may be used as absorbing layers. In some cases, a semiconductor absorber can have stronger optical absorption below a certain wavelength and therefore may be preferred for some applications. Some absorbing materials can have sharp transitions in optical absorption around 530 nm. Amorphous materials can have broad transitions in their optical absorption curves. Amorphous silicon is a semiconductor material with a broad transition in optical absorption. It can be advantageous to adjust the optical properties (e.g., refractive index, extinction coefficient, absorption) by introducing nitrogen or other elements as dopants into the amorphous silicon or chosen absorbing material. In some cases, the resulting material forms an amorphous alloy of the absorbing material and dopant or dopant compound (e.g., amorphous silicon and silicon nitride). Although the alloying process is referred to here as “doping,” it will be appreciated that the dopant is not necessarily behaving as a semiconductor dopant. In some embodiments, the electrical behavior of the resulting alloy could be characterized as a dielectric absorbing material instead of a semiconductor. For the multi-layer absorber filters of the present embodiments, the absorbing layers exhibit at least twice as much optical absorption as the intervening dielectric layers and can further include a difference in refractive index from the intervening layers by more than ten percent or Δn≥0.1.

In many conventional multi-layer dielectric filters, the layers in the filter stack are quarter-wavelength layers and a same thickness for each material is used throughout the stack, such that the stack has a very regular, repeating structure (e.g., t₁, t₂, t₁, t₂, t₁, t₂, t₁, t₂) where t₁ is a thickness of a first dielectric material in the stack and t₂ is a thickness of a second dielectric material in the stack. For a multi-layer semiconductor absorber filter 2-600, the inventors have found that layer thicknesses other than quarter-wavelength and non-uniform thicknesses can improve the filter characteristics. For example, the layers of semiconductor absorbers 2-630 may all have a same thickness tₐ and the layers of dielectric material 2-620 can have different thicknesses that are greater than a quarter wavelength. Improvements can also be obtained when thicknesses of absorbing layers are greater than quarter-wavelength and not a multiple of quarter-wavelength. In some cases, there may be at least three or four different thicknesses of layers within the stack. For example, thickness t₁ can differ from thickness t₂, and both thicknesses can differ from thickness t₃, as depicted in the illustration of FIG. 2-6A. In other cases, both the thicknesses tₛ₁, tₛ₂, . . . tₛ₈ of semiconductor absorbers 2-630 and the thicknesses t_{d1}, t_{d2}, . . . t_{d8} of the layers of dielectric material 2-620 can vary within the stack, as depicted in the multi-layer semiconductor absorber filter 2-700 of FIG. 2-7. Further, some of the layer thicknesses may not correspond to a quarter-wavelength of the radiation for which the filter is designed to block or pass. A quarter-wavelength thickness is determined within the layer, accounting for the refractive index of the layer. The variation in thicknesses for a same material within the stack and/or for different materials may be greater than 20% in some cases, greater than 50% in some cases, and yet greater than 100% in some cases, but may be less than a factor of 10.

According to some embodiments, thicknesses of the semiconductor absorbers 2-630 can be between 20 nm and 300 nm in a multi-layer semiconductor absorber filter. Thicknesses of the layers of dielectric material 2-620 can be between 40 nm and 300 nm. In some cases, the semiconductor absorbers 2-630 can be formed from doped or alloyed amorphous silicon or other semiconductor materials described above. An advantage of using amorphous silicon is that it can be deposited at temperatures that are low enough to be compatible with other CMOS processes (such as processes to form back-end metallization). In some implementations, nitrogen can be used as a dopant or additive, although other dopants or additives (e.g., carbon, phosphorous, germanium, arsenic, etc.) may be used in some absorbers. For the case of nitrogen-doped amorphous silicon, an amount of nitrogen added during deposition of amorphous silicon may be between 0 and 40 atomic percent. This range of doping levels can produce a range of refractive index values between 2.6 and 4.3 and a range of extinction coefficient values between 0.01 and 0.5. Other dopants, semiconductor materials, and doping ranges can be used in other embodiments to obtain different refractive index and extinction coefficient values for a particular wavelength range (e.g., green, blue, or ultraviolet wavelengths or infrared wavelengths).

FIG. 2-6B plots calculated transmission results for a multi-layer semiconductor absorber 2-600 like that illustrated in FIG. 2-6A as a function of wavelength for five different angles of incidence. The multi-layer semiconductor absorber consists of seven layers of nitrogen-doped amorphous silicon absorbers 2-630. For this example, each layer of semiconductor absorber 2-630 is approximately 30 nm thick. The thickness t₁ of the outer most layers of dielectric material 2-620 is approximately 67 nm. The thickness t₂ of the next layers of dielectric material 2-620 moving toward the center of the stack is approximately 108 nm. The thickness t₃ of the inner most layers of dielectric material 2-620 is approximately 95 nm. The multi-layer semiconductor absorber filter 2-600 is embedded in silicon oxide. The index of refraction of the doped amorphous silicon is approximately 3.6 at a wavelength of 532 nm with a value that depends upon the wavelength of radiation. The extinction coefficient k for the doped amorphous silicon is approximately 0.2 at a wavelength of 532 nm, and has a wavelength dependency. The index of refraction of the silicon oxide is approximately 1.5 at a wavelength of 532 nm with a value that also depends upon the wavelength of the radiation incident on the semiconductor absorber.

The filter design, for the results illustrated in FIG. 2-6B, is for an excitation radiation having a characteristic wavelength of approximately 532 nm (indicated by the left shaded bar in the graph). Additionally, two fluorophores are used as described above to increase the effective Stokes shift by FRET and/or DET processes and shift the emission characteristic wavelength to a value in a range between 640 nm and 700 nm (indicated by the right shaded region in the graph). The results suggest a rejection ratio greater than 24,000 may be obtained when including layers in the absorbing filter that are not quarter-wavelength thick. The results also show very good angular dependence of the filter with a high rejection ratio maintained for incidence angles up to 60 degrees.

Further details of angular dependence are shown in FIG. 2-6C for the multi-layer semiconductor absorber filter 2-600 described in connection with FIG. 2-6B. The plotted curves are for s-polarized radiation with a characteristic wavelength of 532 nm incident on the filter at various angles. Results for p-polarized radiation show less angular tolerance. The top trace plots reflectance R of the incident radiation. The middle trace plots absorption A of the incident radiation, and the lower trace plots transmission T of the incident radiation. The angular tolerance to s-polarized radiation is excellent out to about 80 degrees, which is not possible with conventional multi-layer dielectric filters. For example, the rejection ratio is maintained above 10000 for incident angles between 0 degrees and 80 degrees. In some embodiments, the reflectance of the filter can change by less than 20% of its average value over the same incident angle range. Such high rejection ratios and broad angular tolerance were not initially expected by the inventors in a stack that includes non-uniform thicknesses of layers.

It may be appreciated that the performance of the filter can differ depending upon the materials surrounding the filter (e.g., located above and below the filter when integrated into a substrate, such as depicted in FIG. 1-3). For example, reflections from other materials on a substrate may alter the reflectance, absorption, and transmission characteristics of the filter from computational results like those shown in FIGS. 2-6B and FIG. 2-6C when integrated on a substrate.

FIG. 2-7 illustrates another example of a multi-layer semiconductor absorber filter 2-700. This filter design includes variations in thicknesses of both the layers of semiconductor absorbers 2-630 and the layers of dielectric material 2-620. In an example embodiment, the thicknesses of the layers of semiconductor absorbers 2-630 are (from tₛ₁ to tₛ₈, respectively) approximately 32 nm, approximately 153 nm, approximately, 145 nm, approximately 32 nm, approximately 145 nm, approximately 32 nm, approximately 145 nm, and approximately 133 nm. In an implemented device, the thicknesses may be exactly the listed values or within ±5 nm of these values. The thicknesses of the layers of dielectric material 2-620 are (from t_{d1} to t_{d7}, respectively) approximately 56 nm, approximately 100 nm, approximately, 79 nm, approximately 100 nm, approximately 100 nm, approximately 79 nm, and approximately 100 nm. In an implemented device, the thicknesses may be exactly the listed values or within ±5 nm of these values. The filter design illustrated in FIG. 2-7 may be useful for applications where single fluorophores are used (e.g., where FRET or DET is not used).

A multi-layer absorber filter may be formed by sequential timed depositions of absorbing material and dielectric material. The depositions may be timed to achieve desired thicknesses for each layer. Chemical vapor deposition processes may be used. A preferred method of deposition is plasma enhanced chemical vapor deposition (PECVD). The number of absorbing layers deposited can be fewer than 20 in some embodiments, fewer than 10 in some embodiments, and yet fewer than 5 in some embodiments. According to some embodiments, the absorbing layers may be located at regions in an integrated stack that include portions of one or more peaks of electric field within the stack for the excitation radiation. In some cases, the absorbing layers may be located away from peaks in the electric field for emission radiation.

Although the semiconductor absorber 1-235 is shown as a planar layer in FIG. 1-2, the invention is not limited to only planar semiconductor absorbers. In some cases and referring now to FIG. 3-1, a semiconductor absorber 3-135 may be formed on a first layer 3-110 to have topographical structure. The height h of the topographical structure may be between 100 nm and 2000 nm according to some embodiments. In some cases, the height h may be between 1½ times and 3 times a thickness t of the semiconductor absorber. A width w of a depression 3-113 or crest 3-114 in the topographical structure may have any value between 50 nm and 500 microns, according to some embodiments. A second layer 3-112 may be deposited over the semiconductor absorber to fill in the topography, as illustrated in FIG. 3-1.

Topography in a semiconductor absorber 3-135 may be included to relieve in-plane stress in the semiconductor absorber 3-135. In some cases, a semiconductor absorbing material may accumulate in-plane stress as a result of the deposition process. Such stress, if severe enough, can cause warping of the substrate and in some cases cracking and/or delamination of the semiconductor layer. The topography may allow the stress to be relieved and prevent warping, cracking, and delamination. In some embodiments, there may be one or more topographical features in a region of a semiconductor absorber 3-135 that is between the reaction chamber 1-230 and a corresponding sensor 1-122. In some cases, there may be no topography between a reaction chamber 1-230 and a sensor 1-122, and the topography may be in adjacent regions within or between pixels. In some implementations, topographical features in a semiconductor absorber 3-135 may be separated by distances greater than 500 microns (e.g., up to 1 millimeter or more), and in some cases the topographical features may be located outside a pixel region and are sufficient to relieve stress for the pixel region.

Topography in the semiconductor absorber 3-135 may provide additional improvements, in some cases. For example, topography may increase overall absorption of the filter, since longer paths through the absorber will be presented to some incident radiation. Additionally crystallinity of the deposited semiconductor absorbing layer may be improved by the topography (e.g., by inducing or relieving film stress), leading to more abrupt filter cut-off and better rejection ratios.

In some cases, a semiconductor absorber 3-135 that includes topography may be etched back after deposition to form one or more insulated vias 3-210 through the semiconductor absorber, as illustrated in FIG. 3-2. In this example, a vertical interconnect 2-160 can pass through the insulated via 3-210 without electrically connecting to the semiconductor absorbing absorber 3-135. There may be one or more insulated vias 3-210 and vertical interconnects 2-160 within a pixel. The vertical interconnect may connect to other in-plane interconnects 2-170 or potential reference planes above and/or below the semiconductor absorber 3-135. In some embodiments, a filling material 3-230 may be added to fill depressed regions in the semiconductor absorber 3-135. The filling material 3-230 may be of the same material as, or of a different material than, the second layer 3-112 that is formed over the remaining semiconductor absorber 3-135.

In some implementations, there may be no vertical interconnects within a pixel. Instead, a hole may be opened through a semiconductor absorber 1-235, 3-135 and within an insulated via 3-210, so that a wire bond may be made to a contact pad below the semiconductor absorber 3-135. The wire bond may be located outside a pixel region, for example. A hole for a wire bond may be opened by patterning photoresist or a hard mask and etching the semiconductor absorber in an exposed region that is not covered by the photoresist or hard mask. The etched semiconductor absorber may or may not have topographical structure prior to the etching.

FIG. 3-3 depicts another embodiment of the semiconductor absorber 3-135 that is formed to have topographical structure over a first layer 3-110. In this embodiment, an insulated via 3-310 is formed only in regions through which a vertical interconnect 2-160 passes. Adjacent regions may include topography without breaks in the semiconductor absorber 3-135, unlike the structure shown in FIG. 3-2. According to this embodiment, a second layer 3-312 may be formed over regions of the semiconductor absorber adjacent to the insulated via 3-310. The second layer 3-312 may be of the same material as, or of a different material than, the third layer 3-314 that is formed on the second layer 3-312. In embodiments, the first layer 3-110, the second later 3-312, and the third layer 3-314 may comprise transparent or semitransparent material as described above in connection with FIG. 1-1.

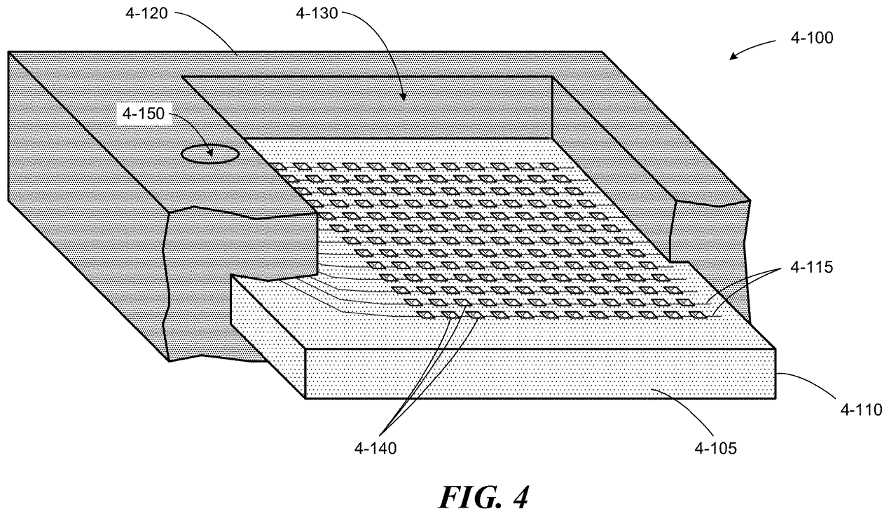

Structure associated with an example method for forming a semiconductor absorber 3-135 having topography and a single insulated via 3-310 are illustrated in FIG. 3-4A through FIG. 3-4E. According to some embodiments, a first resist 3-410 may be deposited and patterned on a first layer 3-110 of transparent or semitransparent material. The first patterned resist 3-410 may be located where a single insulated via 3-310 will be formed. In some embodiments, the first patterned resist 3-410 may be a soft resist, such as a polymeric resist. According to some implementations, a second resist 3-420 may be deposited and patterned on the first layer 3-310. Some of the second patterned resist 3-420 may remain over the first patterned resist 3-410 after exposure and development. The second patterned resist 3-420 that lies over the first patterned resist 3-410 may define the size and location of the insulated via 3-310 that is to be formed. The second patterned resist, according to some embodiments, may be a hard resist such as a nitride, oxide, or metal resist layer. According to some embodiments, the second resist 3-420 exhibits etch selectivity over the first resist 3-410 and over the underlying first layer 3-110. The structure after patterning the first resist 3-410 and second resist 3-420 may appear as shown in FIG. 3-4A.

In a subsequent step of the process, an etching step may be performed to etch away regions of the first layer 3-110 that are not covered by the first patterned resist 3-410 and second patterned resist 3-420. In some cases, a preliminary etch may be carried out to etch away portions of the first patterned resist 3-410 that are not covered by the second patterned resist 3-420. The etching may produce etch cavities 3-430 having cavity walls 3-435, as illustrated in FIG. 3-4B. After the etching, some of the top surface 3-437 of the first layer 3-110 is not etched.

In a subsequent process step, the second patterned resist 3-420 is removed leaving the first patterned resist 3-410. Then, a second etching step may be carried out to further etch the first layer 3-110, as depicted in FIG. 3-4C. In this second etch both the etch cavities 3-430 and the top surface of the first layer 3-437 are etched back without etching a top surface of a pillar 3-440 underneath the first patterned resist 3-410. The resulting pillar 3-440 after completion of the second etch may be taller than the surrounding topography.

After etching topography into the first layer 3-110, the first patterned resist 3-410 can be removed from the first layer 3-110 and the surface of the layer cleaned in preparation for deposition of the semiconductor absorber 3-135. One or more layers of the semiconductor absorber 3-135 may then be deposited over the topography of the first layer 3-110. In some cases, the deposition may be conformal, such that the conformal layers have a uniform thickness (to within 10%) on horizontal and inclined surfaces of the first layer 3-110 as measured normal to the contacting surface. The semiconductor absorber 3-135 may be deposited, for example, by a plasma deposition process or atomic layer deposition process or any other suitable deposition process. Other example deposition processes that may be used to deposit one or more layers of the semiconductor absorber 3-135 include, but are not limited to, sputtering, molecular beam epitaxy, pulsed laser deposition, closed space sublimation, electron-beam evaporation, vapor deposition, chemical vapor deposition, plasma enhanced chemical vapor deposition, electrodeposition, and metal-organic chemical-vapor deposition. In some implementations, where the semiconductor absorber 1-235 is planar, the semiconductor absorber may be deposited by wafer transfer. In some implementations, where the semiconductor absorber 3-135 has topography, the semiconductor absorber and one or more adjacent layers may be deposited by wafer transfer. In some cases the semiconductor absorber layer 3-135 may be annealed after deposition to improve crystallinity of the semiconductor absorber. Subsequently, a second layer 3-312 may be deposited over the semiconductor absorber 3-135 yielding structure as shown in FIG. 3-4D. The second layer 3 312 may have a thickness that is greater than the variation in topography h of the semiconductor absorber 3-135 and first layer 3-110. As noted above, the second layer 3-312 may be of the same type as the first layer 3-110, for example, a semitransparent material such as an oxide or a nitride.

Chemical mechanical polishing (CMP) may then be used to planarize the structure as shown in FIG. 3-4E. In this step, the polishing may remove a portion of the second layer 3-312 and a highest feature of the semiconductor absorber 3-135 to open an insulating via 3-310 as illustrated in FIG. 3-4E. Additional lithography steps may be used to form a conductive vertical interconnect through the insulating via. A third layer 3-314 may be deposited over the second layer 3-312 to form the structure shown in FIG. 3-3. To obtain a structure shown in FIG. 3-2, a first resist 3-410 is not used.

Example structure 4-100 for a disposable chip is shown in FIG. 4, according to some embodiments. The disposable chip structure 4-100 may include a bio-optoelectronic chip 4-110 having a semiconductor substrate 4-105 and including a plurality of pixels 4-140 formed on the substrate. Each pixel 4-140 may have a structure and an embodiment of a semiconductor absorber as described above in connection with FIG. 1-1 through FIG. 3-4E. In embodiments, there may be row are column waveguides 4-115 that provide excitation radiation to a row or column of pixels 4-140. Excitation radiation may be coupled into the waveguides, for example, through an optical port 4-150. In some embodiments, a grating coupler may be formed on the surface of the bio-optoelectronic chip 4-110 to couple excitation radiation from a focused beam into one or more receiving waveguides that connect to the plurality of waveguides 4-115.

The disposable chip structure 4-100 may further include walls 4-120 that are formed around a pixel region on the bio-optoelectronic chip 4-110. The walls 4-120 may be part of a plastic or ceramic casing that supports the bio-optoelectronic chip 4-110. The walls 4-120 may form at least one reservoir 4-130 into which at least one sample may be placed and come into direct contact with reaction chambers 1-130 on the surface of the bio-optoelectronic chip 4-110. The walls 4-120 may prevent the sample in the reservoir 4-130 from flowing into a region containing the optical port 4-150 and grating coupler, for example. In some embodiments, the disposable chip structure 4-100 may further include electrical contacts on an exterior surface of the disposable chip and interconnects within the package, so that electrical connections can be made between circuitry on the bio-optoelectronic chip 4-110 and circuitry in an instrument into which the disposable chip is mounted.

In some embodiments, a semiconductor absorber 2-135 may be integrated at each pixel in a disposable chip structure like that shown in FIG. 4, however the semiconductor absorber 2-135 is not limited to integration in only the assemblies shown and described herein. Semiconductor absorbers of the present embodiments may also be integrated into other semiconductor devices that may not include optical waveguides and/or may not include reaction chambers. For example, semiconductor absorbers of the present embodiments may be integrated into optical sensors for which rejection of one or multiple wavelengths over a range may be desired. In some implementations, semiconductor absorbers of the present embodiments may be incorporated into CCD and/or CMOS imaging arrays. For example, a semiconductor absorber may be formed over a photodiode at one or more pixels in an imaging array so that the absorber filters radiation received by the photodiode(s). Such imaging arrays may be used, for example, in fluorescence microscopy imaging, where excitation radiation is preferentially attenuated by the semiconductor absorber. Such imaging arrays may be used in night-vision goggles, wherein visible radiation is preferentially attenuated while infrared radiation is passed to prevent blinding of the goggles by a bright visible light source, such as an LED.

According to some implementations, a rejection ratio Rᵣ for a semiconductor absorber 2-135 integrated into an assembly can have a value between 10 and 100. In some implementations, the rejection ratio Rᵣ can have a value between 100 and 500. In some cases, the rejection ratio Rᵣ can have a value between 500 and 1000. In some implementations, the rejection ratio Rᵣ can have a value between 1000 and 2000. In some implementations, the rejection ratio Rᵣ can have a value between 2000 and 5000. An advantage of a semiconductor absorber is that the rejection ratio Rᵣ can be selected more easily than for a multi-layer filter by selecting the thickness of the semiconductor absorbing layer, as can be seen from FIG. 2-3. An additional advantage of a semiconductor absorber is that scatter excitation radiation can be absorbed rather than reflected (as would be the case for a multi-layer filter), reducing cross-talk between pixels. Another advantage is that an effective thickness of the semiconductor absorber can be significantly greater than an actual thickness of the semiconductor absorbing layer for rays incident at angles away from normal to the surface of the semiconductor absorbing layer. Further, as noted above, performance of the semiconductor absorber is nowhere near as sensitive to thickness variations of the semiconductor absorbing layer due to microfabrication tolerances as a multi-layer filter's performance is dependent on constituent layer thicknesses.

II. Example Bioanalytic Application

An example bioanalytic application is described in which an integrated semiconductor absorber 1-135 can be used to improve detection of radiation emitted from reaction chambers on a disposable chip that is used in an advanced analytical instrument. For example, a semiconductor absorber 1-135 can significantly reduce excitation radiation incident on the sensor 1-122 and thereby reduce detected background noise appreciably that might otherwise overwhelm emitted radiation from the reaction chamber 1-130. In some cases, as explained in connection with FIG. 2-2 above, the rejection of the excitation radiation can be 800 times more than attenuation of the emission radiation, leading to a significant improvement in signal-to-noise ratio from the sensor 1-122.

When mounted in a receptacle of the instrument, the disposable chip can be in optical and electronic communication with optical and electronic apparatus within the advanced analytic instrument. The instrument may include hardware for an external interface, so that data from the chip can be communicated to an external network. In embodiments, the term “optical” may refer to ultra-violet, visible, near-infrared, and short-wavelength infrared spectral bands. Although various types of analyses can be performed on various samples, the following explanation describes genetic sequencing. However, the invention is not limited to instruments configured for genetic sequencing.

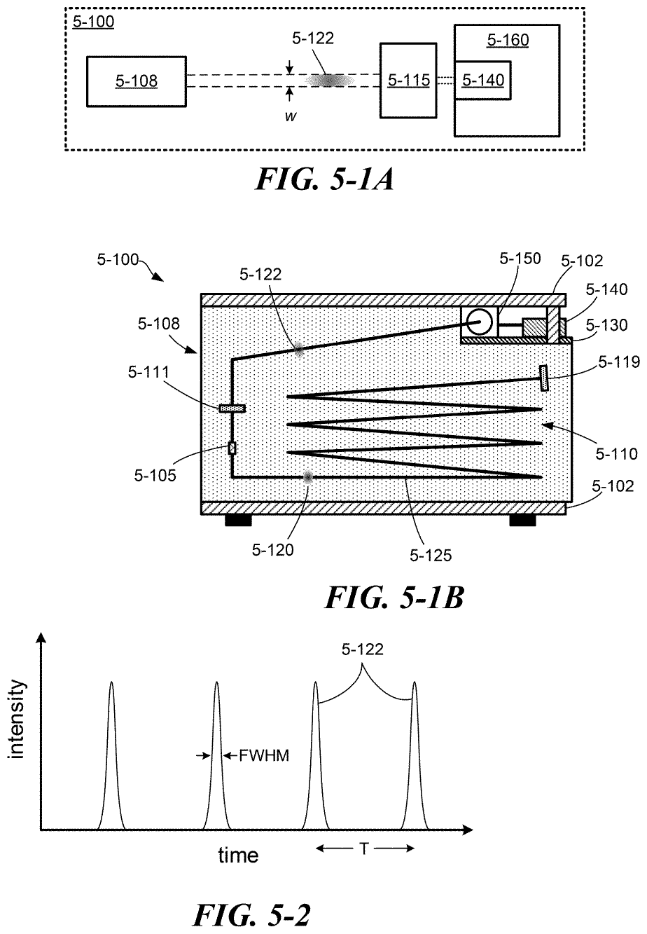

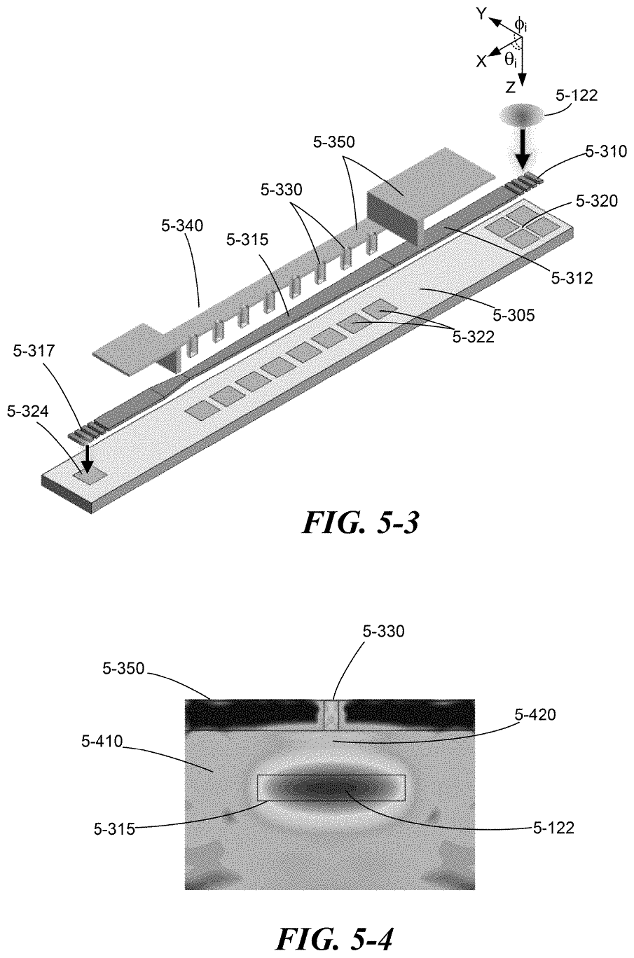

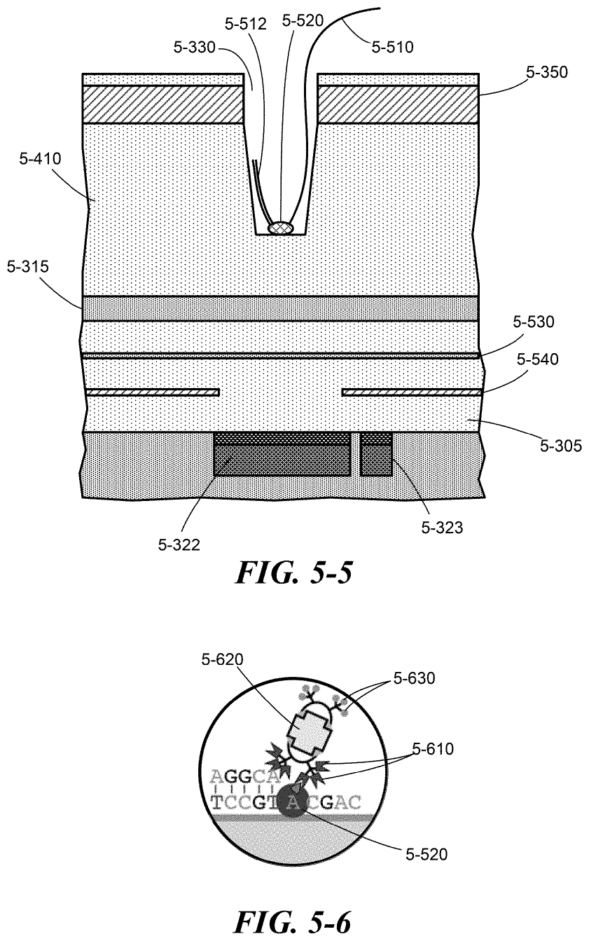

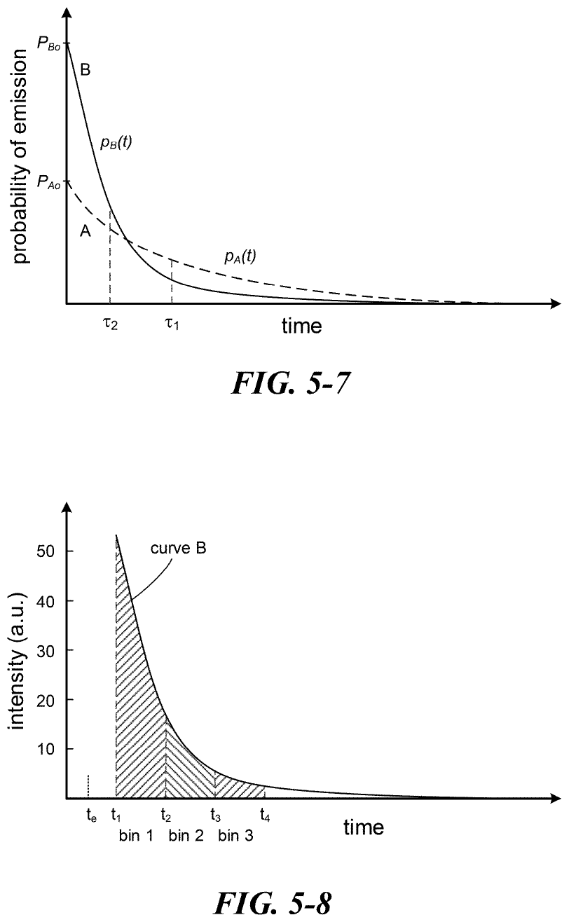

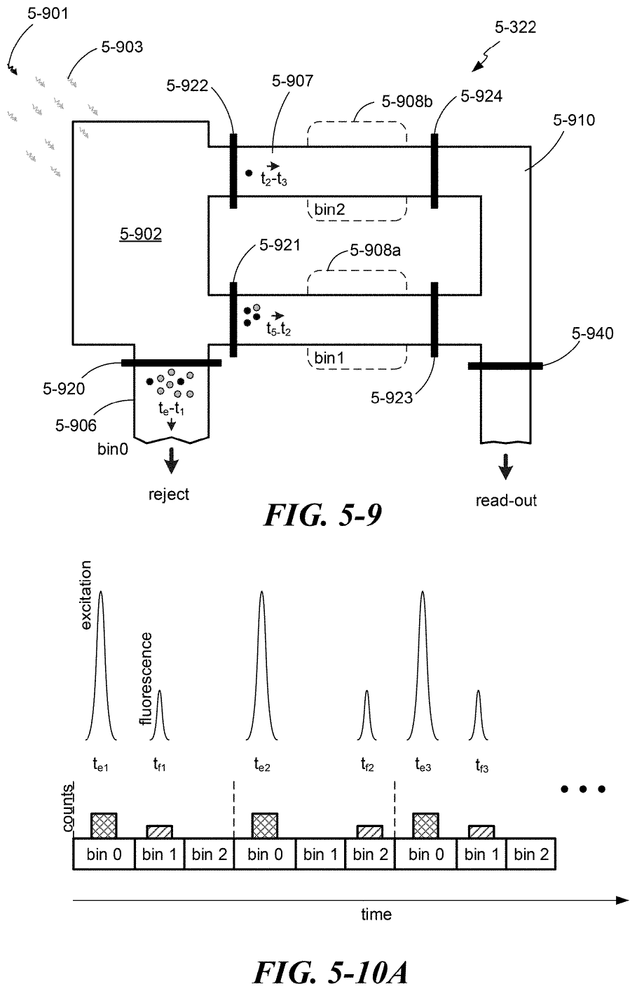

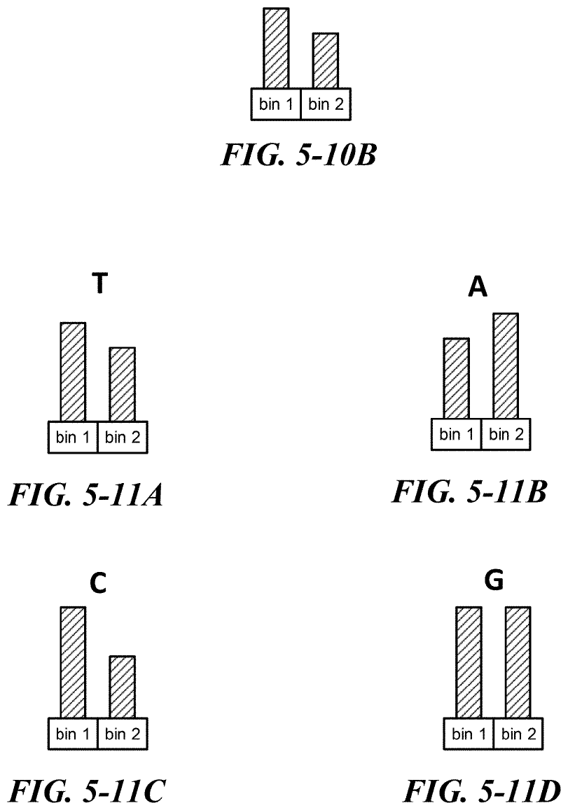

In overview and referring to FIG. 5-1A, a portable, advanced analytic instrument 5-100 can comprise one or more pulsed optical sources 5-108 mounted as a replaceable module within, or otherwise coupled to, the instrument 5-100. The portable analytic instrument 5-100 can include an optical coupling system 5-115 and an analytic system 5-160. The optical coupling system 5-115 can include some combination of optical components (which may include, for example, none, one from among, or more than one component from among the following components: lens, mirror, optical filter, attenuator, beam-steering component, beam shaping component) and be configured to operate on and/or couple output optical pulses 5-122 from the pulsed optical source 5-108 to the analytic system 5-160. The analytic system 5-160 can include a plurality of components that are arranged to direct the optical pulses to at least one reaction chamber for sample analysis, receive one or more optical signals (e.g., fluorescence, backscattered radiation) from the at least one reaction chamber, and produce one or more electrical signals representative of the received optical signals. In some embodiments, the analytic system 5-160 can include one or more photodetectors and may also include signal-processing electronics (e.g., one or more microcontrollers, one or more field-programmable gate arrays, one or more microprocessors, one or more digital signal processors, logic gates, etc.) configured to process the electrical signals from the photodetectors. The analytic system 5-160 can also include data transmission hardware configured to transmit and receive data to and from external devices (e.g., one or more external devices on a network to which the instrument 5-100 can connect via one or more data communications links). In some embodiments, the analytic system 5-160 can be configured to receive a bio-optoelectronic chip 5-140, which holds one or more samples to be analyzed.

FIG. 5-1B depicts a further detailed example of a portable analytical instrument 5-100 that includes a compact pulsed optical source 5-108. In this example, the pulsed optical source 5-108 comprises a compact, passively mode-locked laser module 5-110. A passively mode-locked laser can produce optical pulses autonomously, without the application of an external pulsed signal. In some implementations, the module can be mounted to an instrument chassis or frame 5-102, and may be located inside an outer casing of the instrument. According to some embodiments, a pulsed optical source 5-108 can include additional components that can be used to operate the optical source and operate on an output beam from the optical source 5-108. A mode-locked laser 5-110 may comprise an element (e.g., saturable absorber, acousto-optic modulator, Kerr lens) in a laser cavity, or coupled to the laser cavity, that induces phase locking of the laser's longitudinal frequency modes. The laser cavity can be defined in part by cavity end mirrors 5-111, 5-119. Such locking of the frequency modes results in pulsed operation of the laser (e.g., an intracavity pulse 5-120 bounces back-and-forth between the cavity end mirrors) and produces a stream of output optical pulses 5-122 from one end mirror 5-111 which is partially transmitting.

In some cases, the analytic instrument 5-100 is configured to receive a removable, packaged, bio-optoelectronic or optoelectronic chip 5-140 (also referred to as a “disposable chip”). The disposable chip can include a bio-optoelectronic chip 4-110, as depicted in FIG. 4 for example, that comprises a plurality of reaction chambers, integrated optical components arranged to deliver optical excitation energy to the reaction chambers, and integrated photodetectors arranged to detect fluorescent emission from the reaction chambers. In some implementations, the chip 5-140 can be disposable after a single use, whereas in other implementations the chip 5-140 can be reused two or more times. When the chip 5-140 is received by the instrument 5-100, it can be in electrical and optical communication with the pulsed optical source 5-108 and with apparatus in the analytic system 5-160. Electrical communication may be made through electrical contacts on the chip's package, for example.

In some embodiments and referring to FIG. 5-1B, the disposable chip 5-140 can be mounted (e.g., via a socket connection) on an electronic circuit board 5-130, such as a printed circuit board (PCB) that can include additional instrument electronics. For example, the PCB 5-130 can include circuitry configured to provide electrical power, one or more clock signals, and control signals to the chip 5-140, and signal-processing circuitry arranged to receive signals representative of fluorescent emission detected from the reaction chambers. Data returned from the chip 5-140 can be processed in part or entirely by electronics on the instrument 5-100, although data may be transmitted via a network connection to one or more remote data processors, in some implementations. The PCB 5-130 can also include circuitry configured to receive feedback signals from the chip relating to optical coupling and power levels of the optical pulses 5-122 coupled into waveguides of the chip 5-140. The feedback signals can be provided to one or both of the pulsed optical source 5-108 and optical system 5-115 to control one or more parameters of the output beam of optical pulses 5-122. In some cases, the PCB 5-130 can provide or route power to the pulsed optical source 5-108 for operating the optical source and related circuitry in the optical source 5-108.

According to some embodiments, the pulsed optical source 5-108 comprises a compact mode-locked laser module 5-110. The mode-locked laser can comprise a gain medium 5-105 (which can be solid-state material in some embodiments), an output coupler 5-111, and a laser-cavity end mirror 5-119. The mode-locked laser's optical cavity can be bound by the output coupler 5-111 and end mirror 5-119. An optical axis 5-125 of the laser cavity can have one or more folds (turns) to increase the length of the laser cavity and provide a desired pulse repetition rate. The pulse repetition rate is determined by the length of the laser cavity (e.g., the time for an optical pulse to make a round-trip within the laser cavity).

In some embodiments, there can be additional optical elements (not shown in FIG. 5-1B) in the laser cavity for beam shaping, wavelength selection, and/or pulse forming. In some cases, the end mirror 5-119 comprises a saturable-absorber mirror (SAM) that induces passive mode locking of longitudinal cavity modes and results in pulsed operation of the mode-locked laser. The mode-locked laser module 5-110 can further include a pump source (e.g., a laser diode, not shown in FIG. 5-1B) for exciting the gain medium 5-105. Further details of a mode-locked laser module 5-110 can be found in U.S. patent application Ser. No. 15/844,469, titled “Compact Mode-Locked Laser Module,” filed Dec. 15, 2017, which application is incorporated herein by reference.

When the laser 5-110 is mode locked, an intracavity pulse 5-120 can circulate between the end mirror 5-119 and the output coupler 5-111, and a portion of the intracavity pulse can be transmitted through the output coupler 5-111 as an output pulse 5-122. Accordingly, a train of output pulses 5-122, as depicted in the graph of FIG. 5-2, can be detected at the output coupler as the intracavity pulse 5-120 bounces back-and-forth between the output coupler 5-111 and end mirror 5-119 in the laser cavity.

FIG. 5-2 depicts temporal intensity profiles of the output pulses 5-122, though the illustration is not to scale. In some embodiments, the peak intensity values of the emitted pulses may be approximately equal, and the profiles may have a Gaussian temporal profile, though other profiles such as a sech² profile may be possible. In some cases, the pulses may not have symmetric temporal profiles and may have other temporal shapes. The duration of each pulse may be characterized by a full-width-half-maximum (FWHM) value, as indicated in FIG. 5-2. According to some embodiments of a mode-locked laser, ultrashort optical pulses can have FWHM values less than 100 picoseconds (ps). In some cases, the FWHM values can be between approximately 5 ps and approximately 30 ps.

The output pulses 5-122 can be separated by regular intervals T. For example, T can be determined by a round-trip travel time between the output coupler 5-111 and cavity end mirror 5-119. According to some embodiments, the pulse-separation interval T can be between about 1 ns and about 30 ns. In some cases, the pulse-separation interval T can be between about 5 ns and about 20 ns, corresponding to a laser-cavity length (an approximate length of the optical axis 5-125 within the laser cavity) between about 0.7 meter and about 3 meters. In embodiments, the pulse-separation interval corresponds to a round trip travel time in the laser cavity, so that a cavity length of 3 meters (round-trip distance of 6 meters) provides a pulse-separation interval T of approximately 20 ns.

According to some embodiments, a desired pulse-separation interval T and laser-cavity length can be determined by a combination of the number of reaction chambers on the chip 5-140, fluorescent emission characteristics, and the speed of data-handling circuitry for reading data from the chip 5-140. In embodiments, different fluorophores can be distinguished by their different fluorescent decay rates or characteristic lifetimes. Accordingly, there needs to be a sufficient pulse-separation interval T to collect adequate statistics for the selected fluorophores to distinguish between their different decay rates. Additionally, if the pulse-separation interval T is too short, the data handling circuitry cannot keep up with the large amount of data being collected by the large number of reaction chambers. Pulse-separation interval T between about 5 ns and about 20 ns is suitable for fluorophores that have decay rates up to about 2 ns and for handling data from between about 60,000 and 10,000,000 reaction chambers.

According to some implementations, a beam-steering module 5-150 can receive output pulses from the pulsed optical source 5-108 and is configured to adjust at least the position and incident angles of the optical pulses onto an optical coupler (e.g., grating coupler) of the chip 5-140. In some cases, the output pulses 5-122 from the pulsed optical source 5-108 can be operated on by a beam-steering module 5-150 to additionally or alternatively change a beam shape and/or beam rotation at an optical coupler on the chip 5-140. In some implementations, the beam-steering module 5-150 can further provide focusing and/or polarization adjustments of the beam of output pulses onto the optical coupler. One example of a beam-steering module is described in U.S. patent application Ser. No. 15/161,088 titled “Pulsed Laser and Bioanalytic System,” filed May 20, 2016, which is incorporated herein by reference. Another example of a beam-steering module is described in a separate U.S. Patent Application No. 62/435,679, filed Dec. 16, 2016 and titled “Compact Beam Shaping and Steering Assembly,” which is incorporated herein by reference.

Referring to FIG. 5-3, the output pulses 5-122 from a pulsed optical source can be coupled into one or more optical waveguides 5-312 on a disposable bio-optoelectronic chip 5-140, for example. In some embodiments, the optical pulses can be coupled to one or more waveguides via a grating coupler 5-310, though coupling to an end of one or more optical waveguides on the chip 5-140 can be used in some embodiments. According to some embodiments, a quad detector 5-320 can be located on a semiconductor substrate 5-305 (e.g., a silicon substrate) for aiding in alignment of the beam of optical pulses 5-122 to a grating coupler 5-310. The one or more waveguides 5-312 and reaction chambers or reaction chambers 5-330 can be integrated on the same semiconductor substrate with intervening dielectric layers (e.g., silicon dioxide layers) between the substrate, waveguide, reaction chambers, and photodetectors 5-322.

Each waveguide 5-312 can include a tapered portion 5-315 below the reaction chambers 5-330 to equalize optical power coupled to the reaction chambers along the waveguide. The reducing taper can force more optical energy outside the waveguide's core, increasing coupling to the reaction chambers and compensating for optical losses along the waveguide, including losses for radiation coupling into the reaction chambers. A second grating coupler 5-317 can be located at an end of each waveguide to direct optical energy to an integrated photodiode 5-324. The integrated photodiode can detect an amount of power coupled down a waveguide and provide a detected signal to feedback circuitry that controls the beam-steering module 5-150, for example.

The reaction chambers 5-330 or reaction chambers 5-330 can be aligned with the tapered portion 5-315 of the waveguide and recessed in a tub 5-340. There can be photodetectors 5-322 located on the semiconductor substrate 5-305 for each reaction chamber 5-330. In some embodiments, a semiconductor absorber (shown in FIG. 5-5 as an optical filter 5-530) may be located between the waveguide and a photodetector 5-322 at each pixel. A metal coating and/or multilayer coating 5-350 can be formed around the reaction chambers and above the waveguide to prevent optical excitation of fluorophores that are not in the reaction chambers (e.g., dispersed in a solution above the reaction chambers). The metal coating and/or multilayer coating 5-350 may be raised beyond edges of the tub 5-340 to reduce absorptive losses of the optical energy in the waveguide 5-312 at the input and output ends of each waveguide.

There can be a plurality of rows of waveguides, reaction chambers, and time-binning photodetectors on the chip 5-140. For example, there can be 128 rows, each having 512 reaction chambers, for a total of 65,536 reaction chambers in some implementations. Other implementations may include fewer or more reaction chambers, and may include other layout configurations. Optical power from the pulsed optical source 5-108 can be distributed to the multiple waveguides via one or more star couplers or multi-mode interference couplers, or by any other means, located between an optical coupler 5-310 to the chip 5-140 and the plurality of waveguides 5-312.

FIG. 5-4 illustrates optical energy coupling from an optical pulse 5-122 within a tapered portion of waveguide 5-315 to a reaction chamber 5-330. The drawing has been produced from an electromagnetic field simulation of the optical wave that accounts for waveguide dimensions, reaction chamber dimensions, the different materials' optical properties, and the distance of the tapered portion of waveguide 5-315 from the reaction chamber 5-330. The waveguide can be formed from silicon nitride in a surrounding medium 5-410 of silicon dioxide, for example. The waveguide, surrounding medium, and reaction chamber can be formed by microfabrication processes described in U.S. patent application Ser. No. 14/821,688, filed Aug. 7, 2015, titled “Integrated Device for Probing, Detecting and Analyzing Molecules.” According to some embodiments, an evanescent optical field 5-420 couples optical energy transported by the waveguide to the reaction chamber 5-330.

A non-limiting example of a biological reaction taking place in a reaction chamber 5-330 is depicted in FIG. 5-5. The example depicts sequential incorporation of nucleotides or nucleotide analogs into a growing strand that is complementary to a target nucleic acid. The sequential incorporation can take place in a reaction chamber 5-330, and can be detected by an advanced analytic instrument to sequence DNA. The reaction chamber can have a depth between about 150 nm and about 250 nm and a diameter between about 80 nm and about 160 nm. A metallization layer 5-540 (e.g., a metallization for an electrical reference potential) can be patterned above a photodetector 5-322 to provide an aperture or iris that blocks stray radiation from adjacent reaction chambers and other unwanted radiation sources. According to some embodiments, polymerase 5-520 can be located within the reaction chamber 5-330 (e.g., attached to a base of the chamber). The polymerase can take up a target nucleic acid 5-510 (e.g., a portion of nucleic acid derived from DNA), and sequence a growing strand of complementary nucleic acid to produce a growing strand of DNA 5-512. Nucleotides or nucleotide analogs labeled with different fluorophores can be dispersed in a solution above and within the reaction chamber.

When a labeled nucleotide or nucleotide analog 5-610 is incorporated into a growing strand of complementary nucleic acid, as depicted in FIG. 5-6, one or more attached fluorophores 5-630 can be repeatedly excited by pulses of optical energy coupled into the reaction chamber 5-330 from the waveguide 5-315. In some embodiments, the fluorophore or fluorophores 5-630 can be attached to one or more nucleotides or nucleotide analogs 5-610 with any suitable linker 5-620. An incorporation event may last for a period of time up to about 100 ms. During this time, pulses of fluorescent emission resulting from excitation of the fluorophore(s) by pulses from the mode-locked laser can be detected with a time-binning photodetector 5-322, for example. In some embodiments, there can be one or more additional integrated electronic devices 5-323 at each pixel for signal handling (e.g., amplification, read-out, routing, signal preprocessing, etc.). According to some embodiments, each pixel can include at least one optical filter 5-530 (e.g., a semiconductor absorber) that passes fluorescent emission and reduces transmission of radiation from the excitation pulse. Some implementations may not use the optical filter 5-530. By attaching fluorophores with different emission characteristics (e.g., fluorescent decay rates, intensity, fluorescent wavelength) to the different nucleotides (A,C,G,T), detecting and distinguishing the different emission characteristics while the strand of DNA 5-512 incorporates a nucleic acid and enables determination of the genetic sequence of the growing strand of DNA.

According to some embodiments, an advanced analytic instrument 5-100 that is configured to analyze samples based on fluorescent emission characteristics can detect differences in fluorescent lifetimes and/or intensities between different fluorescent molecules, and/or differences between lifetimes and/or intensities of the same fluorescent molecules in different environments. By way of explanation, FIG. 5-7 plots two different fluorescent emission probability curves (A and B), which can be representative of fluorescent emission from two different fluorescent molecules, for example. With reference to curve A (dashed line), after being excited by a short or ultrashort optical pulse, a probability p_{A}(t) of a fluorescent emission from a first molecule may decay with time, as depicted. In some cases, the decrease in the probability of a photon being emitted over time can be represented by an exponential decay function p_{A}(t)=P_{Ao}e^{-t/τ}^{₁}, where P_{Ao} is an initial emission probability and τ₁ is a temporal parameter associated with the first fluorescent molecule that characterizes the emission decay probability. τ₁ may be referred to as the “fluorescence lifetime,” “emission lifetime,” or “lifetime” of the first fluorescent molecule. In some cases, the value of τ₁ can be altered by a local environment of the fluorescent molecule. Other fluorescent molecules can have different emission characteristics than that shown in curve A. For example, another fluorescent molecule can have a decay profile that differs from a single exponential decay, and its lifetime can be characterized by a half-life value or some other metric.

A second fluorescent molecule may have a decay profile p_{B}(t) that is exponential, but has a measurably different lifetime τ₂, as depicted for curve B in FIG. 5-7. In the example shown, the lifetime for the second fluorescent molecule of curve B is shorter than the lifetime for curve A, and the probability of emission p_{B}(t) is higher sooner after excitation of the second molecule than for curve A. Different fluorescent molecules can have lifetimes or half-life values ranging from about 0.1 ns to about 20 ns, in some embodiments.

Differences in fluorescent emission lifetimes can be used to discern between the presence or absence of different fluorescent molecules and/or to discern between different environments or conditions to which a fluorescent molecule is subjected. In some cases, discerning fluorescent molecules based on lifetime (rather than emission wavelength, for example) can simplify aspects of an analytical instrument 5-100. As an example, wavelength-discriminating optics (such as wavelength filters, dedicated detectors for each wavelength, dedicated pulsed optical sources at different wavelengths, and/or diffractive optics) can be reduced in number or eliminated when discerning fluorescent molecules based on lifetime. In some cases, a single pulsed optical source operating at a single characteristic wavelength can be used to excite different fluorescent molecules that emit within a same wavelength region of the optical spectrum but have measurably different lifetimes. An analytic system that uses a single pulsed optical source, rather than multiple sources operating at different wavelengths, to excite and discern different fluorescent molecules emitting in a same wavelength region can be less complex to operate and maintain, more compact, and can be manufactured at lower cost.

Although analytic systems based on fluorescent lifetime analysis can have certain benefits, the amount of information obtained by an analytic system and/or detection accuracy can be increased by allowing for additional detection techniques. For example, some analytic systems 5-160 can additionally be configured to discern one or more properties of a specimen based on fluorescent wavelength and/or fluorescent intensity.

Referring again to FIG. 5-7, according to some embodiments, different fluorescent lifetimes can be distinguished with a photodetector that is configured to time-bin fluorescent emission events following excitation of a fluorescent molecule. The time binning can occur during a single charge-accumulation cycle for the photodetector. A charge-accumulation cycle is an interval between read-out events during which photo-generated carriers are accumulated in bins of the time-binning photodetector. The concept of determining fluorescent lifetime by time-binning of emission events is introduced graphically in FIG. 5-8. At time tₑ just prior to t₁, a fluorescent molecule or ensemble of fluorescent molecules of a same type (e.g., the type corresponding to curve B of FIG. 5-7) is (are) excited by a short or ultrashort optical pulse. For a large ensemble of molecules, the intensity of emission can have a time profile similar to curve B, as depicted in FIG. 5-8.

For a single molecule or a small number of molecules, however, the emission of fluorescent photons occurs according to the statistics of curve B in FIG. 5-7, for this example. A time-binning photodetector 5-322 can accumulate carriers generated from emission events into discrete time bins. Three bins are indicated in FIG. 5-8, though fewer bins or more bins may be used in embodiments. The bins are temporally resolved with respect to the excitation time tₑ of the fluorescent molecule(s). For example, a first bin can accumulate carriers produced during an interval between times t₁ and t₂, occurring after the excitation event at time tₑ. A second bin can accumulate carriers produced during an interval between times t₂ and t₃, and a third bin can accumulate carriers produced during an interval between times t₃ and t₄. When a large number of emission events are summed, carriers accumulated in the time bins can approximate the decaying intensity curve shown in FIG. 5-8, and the binned signals can be used to distinguish between different fluorescent molecules or different environments in which a fluorescent molecule is located.

Examples of a time-binning photodetector 5-322 are described in U.S. patent application Ser. No. 14/821,656, filed Aug. 7, 2015, titled “Integrated Device for Temporal Binning of Received Photons” and in U.S. patent application Ser. No. 15/852,571, filed Dec. 22, 2017, titled “Integrated Photodetector with Direct Binning Pixel,” which are both incorporated herein by reference in their entirety. For explanation purposes, a non-limiting embodiment of a time-binning photodetector is depicted in FIG. 5-9. A single time-binning photodetector 5-322 can comprise a photon-absorption/carrier-generation region 5-902, a carrier-discharge channel 5-906, and a plurality of carrier-storage bins 5-908a, 5-908b all formed on a semiconductor substrate. Carrier-transport channels 5-907 can connect between the photon-absorption/carrier-generation region 5-902 and carrier-storage bins 5-908a, 5-908b. In the illustrated example, two carrier-storage bins are shown, but there may be more or fewer. There can be a read-out channel 5-910 connected to the carrier-storage bins. The photon-absorption/carrier-generation region 5-902, carrier-discharge channel 5-906, carrier-storage bins 5-908a, 5-908b, and read-out channel 5-910 can be formed by doping the semiconductor locally and/or forming adjacent insulating regions to provide photodetection capability, confinement, and transport of carriers. A time-binning photodetector 5-322 can also include a plurality of electrodes 5-920, 5-921, 5-922, 5-923, 5-924 formed on the substrate that are configured to generate electric fields in the device for transporting carriers through the device.

In operation, a portion of an excitation pulse 5-122 from a pulsed optical source 5-108 (e.g., a mode-locked laser) is delivered to a reaction chamber 5-330 over the time-binning photodetector 5-322. Initially, some excitation radiation photons 5-901 may arrive at the photon-absorption/carrier-generation region 5-902 and produce carriers (shown as light-shaded circles). There can also be some fluorescent emission photons 5-903 that arrive with the excitation radiation photons 5-901 and produce corresponding carriers (shown as dark-shaded circles). Initially, the number of carriers produced by the excitation radiation can be too large compared to the number of carriers produced by the fluorescent emission. The initial carriers produced during a time interval |tₑ−t₁| can be rejected by gating them into a carrier-discharge channel 5-906 with a first electrode 5-920, for example.

At a later times mostly fluorescent emission photons 5-903 arrive at the photon-absorption/carrier-generation region 5-902 and produce carriers (indicated a dark-shaded circles) that provide useful and detectable signal that is representative of fluorescent emission from the reaction chamber 5-330. According to some detection methods, a second electrode 5-921 and third electrode 5-923 can be gated at a later time to direct carriers produced at a later time (e.g., during a second time interval |t₁−t₂|) to a first carrier-storage bin 5-908a. Subsequently, a fourth electrode 5-922 and fifth electrode 5-924 can be gated at a later time (e.g., during a third time interval |t₂−t₃|) to direct carriers to a second carrier-storage bin 5-908b. Charge accumulation can continue in this manner after excitation pulses for a large number of excitation pulses to accumulate an appreciable number of carriers and signal level in each carrier-storage bin 5-908a, 5-908b. At a later time, the signal can be read out from the bins. In some implementations, the time intervals corresponding to each storage bin are at the sub-nanosecond time scale, though longer time scales can be used in some embodiments (e.g., in embodiments where fluorophores have longer decay times).

The process of generating and time-binning carriers after an excitation event (e.g., excitation pulse from a pulsed optical source) can occur once after a single excitation pulse or be repeated multiple times after multiple excitation pulses during a single charge-accumulation cycle for the time-binning photodetector 5-322. After charge accumulation is complete, carriers can be read out of the storage bins via the read-out channel 5-910. For example, an appropriate biasing sequence can be applied to electrodes 5-923, 5-924 and at least to electrode 5-940 to remove carriers from the storage bins 5-908a, 5-908b. The charge accumulation and read-out processes can occur in a massively parallel operation on the chip 5-140 resulting in frames of data.

Although the described example in connection with FIG. 5-9 includes multiple charge storage bins 5-908a, 5-908b in some cases a single charge storage bin may be used instead. For example, only bin1 may be present in a time-binning photodetector 5-322. In such a case, a single storage bins 5-908a can be operated in a variable time-gated manner to look at different time intervals after different excitation events. For example, after pulses in a first series of excitation pulses, electrodes for the storage bin 5-908a can be gated to collect carriers generated during a first time interval (e.g., during the second time interval |t₁−t₂|), and the accumulated signal can be read out after a first predetermined number of pulses. After pulses in a subsequent series of excitation pulses at the same reaction chamber, the same electrodes for the storage bin 5-908a can be gated to collect carriers generated during a different interval (e.g., during the third time interval |t₂−t₃|), and the accumulated signal can be read out after a second predetermined number of pulses. Carriers could be collected during later time intervals in a similar manner if needed. In this manner, signal levels corresponding to fluorescent emission during different time periods after arrival of an excitation pulse at a reaction chamber can be produced using a single carrier-storage bin.

Regardless of how charge accumulation is carried out for different time intervals after excitation, signals that are read out can provide a histogram of bins that are representative of the fluorescent emission decay characteristics, for example. An example process is illustrated in FIGS. 5-10A and FIG. 5-10B, for which two charge-storage bins are used to acquire fluorescent emission from the reaction chambers. The histogram's bins can indicate a number of photons detected during each time interval after excitation of the fluorophore(s) in a reaction chamber 5-330. In some embodiments, signals for the bins will be accumulated following a large number of excitation pulses, as depicted in FIG. 5-10A. The excitation pulses can occur at times tₑ₁, tₑ₂, tₑ₃, . . . t_{eN} which are separated by the pulse interval time T. In some cases, there can be between 10⁵ and 10⁷ excitation pulses 5-122 (or portions thereof) applied to a reaction chamber during an accumulation of signals in the electron-storage bins for a single event being observed in the reaction chamber (e.g., a single nucleotide incorporation event in DNA analysis). In some embodiments, one bin (bin 0) can be configured to detect an amplitude of excitation energy delivered with each optical pulse, and may be used as a reference signal (e.g., to normalize data). In other cases, the excitation pulse amplitude may be stable, determined one or more times during signal acquisition, and not determined after each excitation pulse so that there is no bin0 signal acquisition after each excitation pulse. In such cases, carriers produced by an excitation pulse can be rejected and dumped from the photon-absorption/carrier-generation region 5-902 as described above in connection with FIG. 5-9.

In some implementations, only a single photon may be emitted from a fluorophore following an excitation event, as depicted in FIG. 5-10A. After a first excitation event at time tₑ₁, the emitted photon at time tₑ₁ may occur within a first time interval (e.g., between times t₁ and t₂), so that the resulting electron signal is accumulated in the first electron-storage bin (contributes to bin 1). In a subsequent excitation event at time tₑ₂, the emitted photon at time t_{f2} may occur within a second time interval (e.g., between times t₂ and t₃), so that the resulting electron signal contributes to bin 2. After a next excitation event at time tₑ₃, a photon may emit at a time t_{f3} occurring within the first time interval.

In some implementations, there may not be a fluorescent photon emitted and/or detected after each excitation pulse received at a reaction chamber 5-330. In some cases, there can be as few as one fluorescent photon that is detected at a reaction chamber for every 10,000 excitation pulses delivered to the reaction chamber. One advantage of implementing a mode-locked laser 5-110 as the pulsed excitation source 5-108 is that a mode-locked laser can produce short optical pulses having high intensity and quick turn-off times at high pulse-repetition rates (e.g., between 50 MHz and 250 MHz). With such high pulse-repetition rates, the number of excitation pulses within a 10 millisecond charge-accumulation interval can be 50,000 to 250,000, so that detectable signal can be accumulated.

After a large number of excitation events and carrier accumulations, the carrier-storage bins of the time-binning photodetector 5-322 can be read out to provide a multi-valued signal (e.g., a histogram of two or more values, an N-dimensional vector, etc.) for a reaction chamber. The signal values for each bin can depend upon the decay rate of the fluorophore. For example and referring again to FIG. 5-8, a fluorophore having a decay curve B will have a higher ratio of signal in bin 1 to bin 2 than a fluorophore having a decay curve A. The values from the bins can be analyzed and compared against calibration values, and/or each other, to determine the particular fluorophore present. For a sequencing application, identifying the fluorophore can determine the nucleotide or nucleotide analog that is being incorporated into a growing strand of DNA, for example. For other applications, identifying the fluorophore can determine an identity of a molecule or specimen of interest, which may be linked to the fluorophore or marked with a fluorophore.

To further aid in understanding the signal analysis, the accumulated, multi-bin values can be plotted as a histogram, as depicted in FIG. 5-10B for example, or can be recorded as a vector or location in N-dimensional space. Calibration runs can be performed separately to acquire calibration values for the multi-valued signals (e.g., calibration histograms) for four different fluorophores linked to the four nucleotides or nucleotide analogs. As an example, the calibration histograms may appear as depicted in FIG. 5-11A (fluorescent label associated with the T nucleotide), FIG. 5-11B (fluorescent label associated with the A nucleotide), FIG. 5-11C (fluorescent label associated with the C nucleotide), and FIG. 5-11D (fluorescent label associated with the G nucleotide). A comparison of the measured multi-valued signal (corresponding to the histogram of FIG. 5-10B) to the calibration multi-valued signals can determine the identity “T” (FIG. 5-11A) of the nucleotide or nucleotide analog being incorporated into the growing strand of DNA.

In some implementations, fluorescent intensity can be used additionally or alternatively to distinguish between different fluorophores. For example, some fluorophores may emit at significantly different intensities or have a significant difference in their probabilities of excitation (e.g., at least a difference of about 35%) even though their decay rates may be similar. By referencing binned signals (bins 5-3) to measured excitation energy and/or other acquired signals, it can be possible to distinguish different fluorophores based on intensity levels.

In some embodiments, different numbers of fluorophores of the same type can be linked to different nucleotides or nucleotide analogs, so that the nucleotides can be identified based on fluorophore intensity. For example, two fluorophores can be linked to a first nucleotide (e.g., “C”) or nucleotide analog and four or more fluorophores can be linked to a second nucleotide (e.g., “T”) or nucleotide analog. Because of the different numbers of fluorophores, there may be different excitation and fluorophore emission probabilities associated with the different nucleotides. For example, there may be more emission events for the “T” nucleotide or nucleotide analog during a signal accumulation interval, so that the apparent intensity of the bins is significantly higher than for the “C” nucleotide or nucleotide analog.

Distinguishing nucleotides or any other biological or chemical specimens based on fluorophore decay rates and/or fluorophore intensities enables a simplification of the optical excitation and detection systems in an analytical instrument 5-100. For example, optical excitation can be performed with a single-wavelength source (e.g., a source producing one characteristic wavelength rather than multiple sources or a source operating at multiple different characteristic wavelengths). Additionally, wavelength-discriminating optics and filters may not be needed in the detection system to distinguish between fluorophores of different wavelengths. Also, a single photodetector can be used for each reaction chamber to detect emission from different fluorophores.

The phrase “characteristic wavelength” or “wavelength” is used to refer to a central or predominant wavelength within a limited bandwidth of radiation (e.g., a central or peak wavelength within a 20 nm bandwidth output by a pulsed optical source). In some cases, “characteristic wavelength” or “wavelength” may be used to refer to a peak wavelength within a total bandwidth of radiation output by a source.

Fluorophores having emission wavelengths in a range between about 560 nm and about 900 nm can provide adequate amounts of fluorescence to be detected by a time-binning photodetector (which can be fabricated on a silicon wafer using CMOS processes). These fluorophores can be linked to biological molecules of interest, such as nucleotides or nucleotide analogs for genetic sequencing applications. Fluorescent emission in this wavelength range can be detected with higher responsivity in a silicon-based photodetector than fluorescence at longer wavelengths. Additionally, fluorophores and associated linkers in this wavelength range may not interfere with incorporation of the nucleotides or nucleotide analogs into growing strands of DNA. In some implementations, fluorophores having emission wavelengths in a range between about 560 nm and about 660 nm can be optically excited with a single-wavelength source. An example fluorophore in this range is Alexa Fluor 647, available from Thermo Fisher Scientific Inc. of Waltham, Mass.

Excitation energy at shorter wavelengths (e.g., between about 500 nm and about 650 nm) may be used to excite fluorophores that emit at wavelengths between about 560 nm and about 900 nm. In some embodiments, the time-binning photodetectors can efficiently detect longer-wavelength emission from the reaction chambers, e.g., by incorporating other materials, such as Ge, into the photodetectors' active regions.

Embodiments of absorbing filters and related methods are possible in various configurations as described further below. Example device configurations include combinations of configurations (1) through (8) as described below.

(1) A multi-layer absorber filter comprising: a plurality of layers of absorbers, such as semiconductor absorbers; and a plurality of layers of dielectric material separating the plurality of absorbers to form a multi-layer stack, wherein there are at least three different layer thicknesses within the multi-layer stack. The absorbers may be semiconductor absorbers.

(2) The filter of configuration (1), wherein the plurality of layers of dielectric material include at least two different thicknesses.

(3) The filter of configuration 1 or 2, wherein the plurality of layers of absorbers include at least two different thicknesses.

(4) The filter of any one of configurations (1) through (3), wherein there are at least four different layer thicknesses within the stack.

(5) The filter of any one of configurations (1) through (4), wherein some of the thicknesses within the stack do not correspond to a quarter-wavelength of radiation for which the filter is designed to block.

(6) The filter of any one of configurations (1) through (5), wherein at least two of the three different layer thicknesses differ by more than 50%.

(7) The filter of any one of configurations (1) through (6), wherein the layers of absorbers comprise doped silicon.

(8) The filter of any one of configurations (1) through (7), wherein thicknesses of the layers of absorbers are between 20 nm and 300 nm.

Methods for making an absorber filter can include various processes. Example methods include combinations of processes (9) through (13) as described below. These processes may be used, at least in part, to make an absorbing filter of the configurations listed above.

(9) A method of forming a multi-layer absorber filter, the method comprising: depositing a plurality of layers of absorbers; and depositing a plurality of layers of dielectric material that separate the plurality of absorbers to form a multi-layer stack, wherein at least three different layer thicknesses are deposited within the multi-layer stack.

(10) The method of (9), wherein depositing the plurality of layers of absorbers comprises depositing at least two different thicknesses of absorbers that differ by at least 20%.

(11) The method of (9) or (10), wherein depositing the plurality of layers of absorbers comprises depositing layers of absorbers that are not quarter-wavelength thick.

(12) The method of any one of (9) through (11), wherein depositing the plurality of layers of dielectric material comprises depositing at least two different thicknesses of dielectric material that differ by at least 20%.

(13) The method of any one of (9) through (12), wherein depositing the plurality of layers of dielectric material comprises depositing layers of dielectric material that are not quarter-wavelength thick.

Embodiments of absorbing filters can be included in fluorescence detection assemblies. Examples of such embodiments are listed in configurations (14) through (42).

(14) A fluorescence detection assembly, comprising: a substrate having an optical detector formed thereon; a reaction chamber arranged to receive a fluorescent molecule; an optical waveguide disposed between the optical detector and the reaction chamber; and an optical absorption filter comprising a semiconductor absorbing layer disposed between the optical detector and the reaction chamber.

(15) The assembly of configuration (14), further comprising: an iris layer having an opening between the reaction chamber and the optical detector; a first capping layer contacting a first side of the semiconductor absorbing layer; a hole passing through the first capping layer and semiconductor absorbing layer; and a conductive interconnect extending through the hole.

(16) The assembly of configuration (14) or (15), further comprising at least one dielectric layer arranged in a stack with the semiconductor absorbing layer to form an absorptive-interference filter, wherein a rejection ratio for the stack is greater than a rejection ratio for the semiconductor absorbing layer alone.

(17) The assembly of any one of configurations (14) through (16), further comprising at least one dielectric layer arranged in a stack with the semiconductor absorbing layer and at least one additional semiconductor absorbing layer to form an absorptive-interference filter, wherein a rejection ratio for the stack is greater than a rejection ratio for the semiconductor absorbing layer alone.

(18) The assembly of any one of configurations (14) through (17), wherein the semiconductor absorbing layer comprises a bandgap sufficient to absorb excitation radiation of a first wavelength directed at the reaction chamber and to transmit emission radiation of a second wavelength from the reaction chamber.

(19) The assembly of configuration (18), wherein the first wavelength corresponds to the green region of the visible electromagnetic spectrum, and the second wavelength corresponds to the yellow region or red region of the visible electromagnetic spectrum.

(20) The assembly of configuration (19), wherein the first wavelength is in a range from 515 nanometers (nm) to 540 nm and the second wavelength is in a range from 620 nm to 650 nm.

(21) The assembly of configuration (19), wherein the first wavelength is approximately 532 nm and the second wavelength is approximately 572 nanometers.

(22) The assembly of configuration (18), wherein the bandgap is in a range from 2.2 eV to 2.3 eV.

(23) The assembly of any one of configurations (14) through (22), wherein the semiconductor absorbing layer comprises a binary II-VI semiconductor.

(24) The assembly of configuration (23), wherein the semiconductor absorbing layer is zinc telluride.

(25) The assembly of configuration (23), wherein the semiconductor absorbing layer is alloyed with a third element from group II or group VI.

(26) The assembly of any one of configurations (14) through (22), wherein the semiconductor absorbing layer comprises a ternary III-V semiconductor.

(27) The assembly of configuration (26), wherein the semiconductor absorbing layer is indium gallium nitride.

(28) The assembly of any one of configurations (14) through (27), wherein the semiconductor absorbing layer is amorphous.

(29) The assembly of any one of configurations (14) through (27), wherein the semiconductor absorbing layer is polycrystalline.

(30) The assembly of any one of configurations (14) through (27), wherein the semiconductor absorbing layer has an average crystal grain size no smaller than 20 nm.

(31) The assembly of any one of configurations (14) through (27), wherein the semiconductor absorbing layer is essentially single crystal.

(32) The assembly of any one of configurations (14) through (31), further comprising a first capping layer contacting the semiconductor absorbing layer.

(33) The assembly of configuration (32), wherein the capping layer prevents diffusion of an element from the semiconductor absorbing layer.

(34) The assembly of configuration (32) or (33), wherein the capping layer comprises a refractory metal oxide with thickness from 5 nm to 200 nm.

(35) The assembly of configuration (34), wherein the refractory metal oxide comprises tantalum oxide, titanium oxide, or hafnium oxide.

(36) The assembly of any one of configurations (32) through (35), wherein the capping layer reduces optical reflection from the semiconductor absorbing layer for a visible wavelength between 500 nm and 750 nm.

(37) The assembly of any one of configurations (32) through (36), wherein the capping layer provides increased adhesion of the semiconductor absorbing layer in the assembly.

(38) The assembly of any one of configurations (32) through (37), wherein the capping layer reduces in-plane stress from the semiconductor absorbing layer in the assembly.

(39) The assembly of any one of configurations (14) through (38), further comprising an opening formed through the optical absorption filter and an electrically-conductive connection extending through the opening.

(40) The assembly of any one of configurations (14) through (39), wherein the optical absorption filter is formed over non-planar topography.

(41) The assembly of configuration (40), further comprising an opening formed through the optical absorption filter and an electrically-conductive connection extending through the opening.

(42) The assembly of configuration (41), wherein the opening is located at a planarized interface between the optical absorption filter and an adjacent layer and at which the semiconductor absorbing layer has been removed.

Additional embodiments of an optical absorption filter are described in configurations (43) through (54).

(43) An optical absorption filter comprising a semiconductor absorbing layer formed over non-planar topography on a substrate.

(44) The optical absorption filter of configuration (43), wherein at least a portion of the semiconductor absorbing layer has been removed by planarization.

(45) The optical absorption filter of configuration (44), further comprising an electrically-conductive, connection extending through an opening formed by a removed portion of the semiconductor absorbing layer.

(46) The optical absorption filter of any one of configurations (43) through (45), wherein the semiconductor absorbing layer has a uniform thickness to within 10% and conforms to the non-planar topography.

(47) The optical absorption filter of configuration (46), wherein portions of the semiconductor absorbing layer extend essentially orthogonal to a plane of the substrate.

(48) An optical absorption filter comprising a ternary III-V semiconductor absorbing layer formed in an integrated device on a substrate.

(49) The optical absorption filter of configuration (48), wherein the ternary III-V semiconductor absorbing layer is single crystal.

(50) The optical absorption filter of configuration (48) or (49), wherein the ternary III-V semiconductor absorbing layer is indium-gallium nitride.

(51) The optical absorption filter of any one of configurations (48) through (50), wherein the integrated device includes an optical detector and a reaction chamber located on opposite sides of the optical absorption filter.

(52) The optical absorption filter of configuration (51), wherein the integrated device further includes an optical waveguide located on a same side of the optical absorption filter as the reaction chamber.

(53) The optical absorption filter of any one of configurations (48) through (50), wherein the integrated device includes an optical detector and an optical waveguide located on opposite sides of the optical absorption filter.

(54) The optical absorption filter of any one of configurations (48) through (53), further comprising an anti-reflection layer formed adjacent to the semiconductor absorbing layer that is configured to reduce optical reflection from the semiconductor absorbing layer for a visible wavelength between 500 nm and 750 nm.

Various methods for forming a fluorescence detection device are possible. Example methods include combinations of processes (55) through (58) as described below. These processes may be used, at least in part, to make a fluorescence detection device of the configurations listed above.

(55) A method for forming fluorescence detection device, the method comprising: forming an optical detector on a substrate; forming a semiconductor optical absorption filter over the optical detector on the substrate; forming an optical waveguide over the optical detector on the substrate; and forming a reaction chamber configured to receive a fluorescent molecule over the optical absorption filter and the optical waveguide.

(56) The method of (55), wherein forming the semiconductor optical absorption filter comprises depositing a semiconductor absorbing layer conformally over non-planar topography.

(57) The method of (55) or (56), further comprising forming an oxide or nitride capping layer in contact with the semiconductor absorbing layer to prevent diffusion of an element from the semiconductor absorbing layer.

(58) The method of (57), further comprising forming the oxide or nitride capping layer adjacent to the semiconductor absorbing layer with a thickness that reduces optical reflection from the semiconductor absorbing layer for a visible wavelength between 500 nm and 750 nm compared to a case where the oxide or nitride capping layer is not present.

Various methods for improving signal-to-noise ratio for an optical detector are possible. Example methods include combinations of processes (59) through (66) as described below.

(59) A method of improving signal-to-noise for an optical detector, the method comprising: delivering, with an optical waveguide, excitation radiation to a reaction chamber, wherein the optical waveguide and reaction chamber are integrated on a substrate; passing emission radiation from the reaction chamber through an optical absorption filter comprising a semiconductor absorbing layer; detecting emission radiation that has passed through the semiconductor absorbing layer with an optical detector; and attenuating, with the semiconductor absorbing layer, excitation radiation travelling toward the optical detector.

(60) The method of (59), further comprising attenuating, with the semiconductor absorbing layer, the excitation radiation travelling toward the optical detector between 10 times and 100 times more than attenuating the emission radiation that has passed through the semiconductor absorbing layer.

(61) The method of (59), further comprising attenuating, with the semiconductor absorbing layer, the excitation radiation travelling toward the optical detector between 100 times and 1000 times more than attenuating the emission radiation that has passed through the semiconductor absorbing layer.

(62) The method of (59), further comprising attenuating, with the semiconductor absorbing layer, the excitation radiation travelling toward the optical detector between 1000 times and 3000 times more than attenuating the emission radiation that has passed through the semiconductor absorbing layer.

(63) The method of any one of (59) through (62), wherein the excitation radiation has a first characteristic wavelength in a range from 500 nm to 540 nm and the emission radiation has a second characteristic wavelength between 560 nm and 690 nm.

(64) The method of any one of (59) through (63), further comprising passing the emission radiation through a first capping layer that contacts the semiconductor absorbing layer.

(65) The method of (64), further comprising reducing a reflection of the emission radiation from the semiconductor absorbing layer with the first capping layer.

(66) The method of any one of (59) through (65), wherein the first capping layer comprises a refractory metal oxide with thickness from 5 nm to 200 nm.

(67) The method of any one of (59) through (66), further comprising reducing, with the capping layer, in-plane stress from the semiconductor absorbing layer.

### IV. Conclusion

Having thus described several aspects of several embodiments of system architecture for an advanced analytic system 5-100, it is to be appreciated that various alterations, modifications, and improvements will readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated, those of ordinary skill in the art will readily envision a variety of other means and/or structures for performing the function and/or obtaining the results and/or one or more of the advantages described, and each of such variations and/or modifications is deemed to be within the scope of the inventive embodiments described. More generally, those skilled in the art will readily appreciate that all parameters, dimensions, materials, and configurations described are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure may be directed to each individual feature, system, system upgrade, and/or method described. In addition, any combination of two or more such features, systems, and/or methods, if such features, systems, system upgrade, and/or methods are not mutually inconsistent, is included within the inventive scope of the present disclosure.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used are for organizational purposes only and are not to be construed as limiting the subject matter described in any way.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10±δ1 and 20±δ2” in some embodiments. The amount of variation δ1, δ2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation δ1, δ2 for a value could be as high as 50%. For example, if an operable range extends from 2 to 200, “approximately 80” may encompass values between 40 and 120 and the range may be as large as between 1 and 300. When exact values are intended, the term “exactly” is used, e.g., “between exactly 2 and exactly 200.”

The term “adjacent” may refer to two elements arranged within close proximity to one another (e.g., within a distance that is less than about one-fifth of a transverse or vertical dimension of a larger of the two elements). In some cases there may be intervening structures or layers between adjacent elements. In some cases adjacent elements may be immediately adjacent to one another with no intervening structures or elements.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A multi-layer absorber filter comprising:
a plurality of layers of absorbers; and
a plurality of layers of dielectric material separating the plurality of absorbers to form a multi-layer stack, wherein there are at least three different layer thicknesses within the multi-layer stack.

2. The filter of claim 1, wherein the plurality of layers of dielectric material include at least two different thicknesses.

3. The filter of claim 1, wherein the plurality of layers of absorbers include at least two different thicknesses.

4. The filter of claim 1, wherein there are at least four different layer thicknesses within the stack.

5. The filter of claim 1, wherein some of the thicknesses within the stack do not correspond to a quarter-wavelength of radiation for which the filter is designed to block.

6. The filter of claim 1, wherein at least two of the three different layer thicknesses differ by more than 50%.

7. The filter of claim 1, wherein the absorbers comprise a semiconductor material.

8. The filter of claim 1, wherein the absorbers comprise an alloy that includes a semiconductor material.

9. The filter of claim 1, wherein the layers of absorbers comprise doped silicon.

10. The filter of claim 1, wherein thicknesses of the layers of absorbers are between 20 nm and 300 nm.

11. A method of forming a multi-layer absorber filter, the method comprising:
depositing a plurality of layers of absorbers; and
depositing a plurality of layers of dielectric material that separate the plurality of absorbers to form a multi-layer stack, wherein at least three different layer thicknesses are deposited within the multi-layer stack.

12. The method of claim 11, wherein depositing the plurality of layers of absorbers comprises depositing at least two different thicknesses of absorbers that differ by at least 20%.

13. The method of claim 11, wherein depositing the plurality of layers of absorbers comprises depositing layers of absorbers that are not quarter-wavelength thick.

14. The method of claim 11, wherein depositing the plurality of layers of absorbers comprises depositing layers of an alloy that includes a semiconductor material.

15. The method of claim 11, wherein depositing the plurality of layers of absorbers comprises depositing doped amorphous silicon.

16. The method of claim 11, wherein depositing the plurality of layers of dielectric material comprises depositing at least two different thicknesses of dielectric material that differ by at least 20%.

17. The method of claim 11, wherein depositing the plurality of layers of dielectric material comprises depositing layers of dielectric material that are not quarter-wavelength thick.

18. A fluorescence detection assembly, comprising:
a substrate having an optical detector formed thereon;
a reaction chamber arranged to receive a fluorescent molecule;
an optical waveguide disposed between the optical detector and the reaction chamber; and
an optical absorption filter comprising at least one absorbing layer disposed between the optical detector and the reaction chamber.

19. The assembly of claim 18, wherein the optical absorption filter comprises:
a plurality of layers of absorbers; and
a plurality of layers of dielectric material separating the plurality of absorbers to form a multi-layer stack, wherein there are at least three different layer thicknesses within the multi-layer stack.

20. The assembly of claim 18, further comprising at least one dielectric layer arranged in a stack with the at least one absorbing layer to form an absorptive-interference filter.

21. The assembly of claim 18, wherein the at least one absorbing layer comprises a bandgap sufficient to absorb excitation radiation of a first wavelength directed at the reaction chamber and to transmit at least twice as much emission radiation of a second wavelength from the reaction chamber than an amount of excitation radiation that is absorbed.

22. The assembly of claim 21, wherein the first wavelength corresponds to the green region of the visible electromagnetic spectrum, and the second wavelength corresponds to the yellow region or red region of the visible electromagnetic spectrum.

23. The assembly of claim 22, wherein the first wavelength is in a range from 515 nanometers (nm) to 540 nm and the second wavelength is in a range from 620 nm to 650 nm.

24. The assembly of claim 18, wherein the at least one absorbing layer comprises an alloy that includes a semiconductor material.

25. The assembly of claim 18, wherein the at least one absorbing layer comprises doped amorphous silicon.
